(19) United States
(12) Patent Application Publication
(10) Pub. No.: US 2026/0094371 A1
(43) Pub. Date: Apr. 2, 2026

(54) 3D SCENE RECONSTRUCTION USING VOXELIZED GAUSSIAN SPLAT REPRESENTATIONS

(71) Applicant: NVIDIA Corporation, Santa Clara, CA (US)

(72) Inventors: Xuanchi REN, Toronto (CA); Yifan LU, Shanghai (CN); Jiahui HUANG, Santa Clara, CA (US); Francis WILLIAMS, Brooklyn, NY (US); Hanxue LIANG, Cambridge (GB); Zhangjie WU, Toronto (CA); Huan LING, Toronto (CA); Kezhao CHEN, Shanghai (CN); Sanja FIDLER, Toronto (CA)

(73) Assignee: NVIDIA Corporation, Santa Clara, CA (US)

(21) Appl. No.: 18/924,298

(22) Filed: Oct. 23, 2024

(30) Foreign Application Priority Data
Sep. 30, 2024 (WO) PCT/CN2024/122991

(51) Int. Cl. G06T 17/20; G06T 7/60; G06T 7/73; G06T 17/05; G06T 19/20

(52) U.S. Cl. CPC G06T 17/20; G06T 7/60; G06T 7/75; G06T 17/05; G06T 19/20; G06T 2200/04; G06T 2207/20084; G06T 2207/30261; G06T 2210/56

(57) ABSTRACT

Embodiments of the present disclosure relates to at least one processor including one or more circuits to implement a generative geometry network and an appearance network. The generative geometry network includes a first diffusion model conditioned on at least one input image, the first diffusion model configured to generate a first voxel grid having a first resolution, and a second diffusion model conditioned on the first voxel grid. The second diffusion model configured to generate a second voxel grid having a second resolution. The second resolution is greater than the first resolution, the first voxel grid and the second voxel grid represent a three dimensional (3D) scene. The appearance network predicts one or more Gaussian attributes within one or more voxels of the second voxel grid, determines a representation of a portion of the 3D scene that corresponds to a sky using the at least one input image, and composes a novel view of the 3D scene based at least in part of the Gaussian attributes and the representation of a portion of the 3D scene that corresponds to a sky.

### CROSS-REFERENCE TO RELATED APPLICATIONS

The present application claims priority to International Application No. PCT/CN2024/122991, filed Sep. 30, 2024, the disclosure of which is incorporated herein by reference in its entirety.

### BACKGROUND

Recovering and reconstructing three dimensional (3D) geometry and appearance from images is a fundamental technical problem in computer vision and graphics and have been studied for decades. 3D reconstruction lies at the core of many practical applications spanning from robotics, autonomous driving, and augmented reality.

Early algorithms that seek to address 3D reconstruction use stereo matching and structure from motion to recover 3D signals from image data. Recent approaches that use techniques such as neural radiance fields (NeRFs) have augmented traditional structure-from-motion (SfM) pipelines by fitting a volumetric field to a set of images, to allow different views of the volumetric field to be rendered. For example, NeRFs augment traditional reconstruction pipelines by encoding dense geometry as a representation that can be used to synthesize novel views. However, radiance-field methods require a time-consuming, resource-consuming per-scene optimization scheme. Furthermore, as each scene is recovered in isolation, radiance fields cannot use data priors and therefore cannot extrapolate reconstructions away from the input views. Radiance-field methods also require dense view coverage in order to produce high-quality 3D reconstructions, and are susceptible to failure when view coverage is sparse.

Another conventional 3D reconstruction method leverages deep learning to predict 3D environment from input images. Such methods meta-learn an initialization to the radiance-field optimization problem or directly predict a 3D environment from images using a feed-forward network. Methods involving feed-forward networks predicts per-image per-pixel depth or global coordinates, and the resulting 3D reconstruction suffers from small-scale and ray-based artifacts. Learning-based approaches are (generally) only successful for predicting single objects at low resolutions. Furthermore, learning-based approaches often suffer from 3D inconsistencies (e.g., the multi-layer surfaces or the Janus problem).

3D reconstruction is difficult to implement in practice given that high-quality ground-truth 3D data is not widely available for scenes, 3D representations for deep learning that scale to large and diverse inputs are under-explored in the field, and corresponding scalable and easy-to-train model designs need to be developed alongside any new 3D representation. Further, some conventional solutions learn data prior from the 2D space and cannot generate geometry that is occluded from the input images.

### SUMMARY

Embodiments of the present disclosure relate to 3D scene reconstruction using voxelized Gaussian splatting (“VoxSplats”) representations, arranged in a hierarchy for accelerated processing. The present disclosure is directed to systems, methods, and non-transitory computer-readable media for reconstructing 3D scenes based on at least one input image. The 3D reconstruction methods (e.g., SCube) described herein can generalize reconstruction to general 3D scenes, produce accurate and high-quality 3D reconstructions in the presence of dense views and leverage data priors to produce plausible reconstructions in sparse-view applications, and run quickly and efficiently (in terms of both runtime and memory) on large-scale and high-resolution input images. Implementations of the present disclosure can achieve reconstruction within tens of seconds. The machine learning model as described herein can learn a 3D prior distribution of a scene geometry and scale up to scenes having sizes of 100 m by 100 m.

In one or more embodiments of the present disclosure, a reconstructed 3D scene is represented, defined, or encoded by VoxSplats, which is a set of Gaussian splats supported on a sparse voxel grid or a high-resolution sparse-voxel scaffold. In other words, 3D scenes can be encoded as a hybrid of Gaussian splats, supported on a sparse-voxel-hierarchy. Gaussian splats enable fast rendering, and sparse-voxel-hierarchy provides efficient generative modeling of large 3D scenes with semantics. By leveraging sparse voxel grids, the priors can be learned in true 3D space represented using sparse voxels, leading to high-quality novel view rendering and sensor simulation. One or more embodiments of the present disclosure may be implemented as or with a pipeline to reconstruct a VoxSplat from input images. In at least one implementation, the pipeline includes a hierarchical voxel latent diffusion model conditioned on the input images, followed by a feed-forward appearance prediction model. The diffusion model generates progressively higher resolution 3D grids in a coarse-to-fine manner, and an appearance network (including the feed-forward appearance prediction model) predicts a set of Gaussians (Gaussian Splats) within each voxel. In some examples, from as few as 3 non-overlapping input images, millions of Gaussians can be within a 10243 voxel grid, spanning hundreds of meters in 20 seconds.

One or more embodiments may be implemented using at least one processor that includes one or more circuits to implement a generative geometry network and an appearance network. The generative geometry network includes a first diffusion model conditioned on at least one input image. The first diffusion model is configured to generate a first voxel grid having a first resolution, and a second diffusion model conditioned on the first voxel grid. The second diffusion model is configured to generate a second voxel grid having a second resolution that is greater than the first resolution, with the first voxel grid and the second voxel grid representative of a three dimensional (3D) scene. The appearance network predicts Gaussian attributes within voxels of the second voxel grid, determines a sky panorama using the at least one input image, and composes a novel view of the 3D scene based at least in part of the Gaussian attributes and the sky panorama.

One or more embodiments may be implemented using at least one processor that includes one or more circuits to: generate a first voxel grid having a first resolution and being conditioned on at least one input image; generate a second voxel grid having a second resolution conditioned on the first voxel grid, wherein the second resolution is greater than the first resolution, with the first voxel grid and the second voxel grid representative of a three dimensional (3D) scene. The one or more circuits are further to: predict one or more Gaussian attributes within one or more voxels of the second voxel grid, determine a sky panorama using the at least one input image, and compose a novel view of the 3D scene based at least in part of the Gaussian attributes and the sky panorama.

One or more embodiments may be implemented with at least one processor that includes one or more circuits to update at least one Variational Autoencoder (VAE) to learn a latent space over a sparse voxel hierarchy. In at least one embodiment, the sparse voxel hierarchy includes a first voxel grid having a first resolution and a second voxel grid having a second resolution generated by the at least one VAE. In at least one embodiment, the second resolution is greater than the first resolution. In at least one embodiment, the one or more circuits add semantic logit prediction to the second voxel grid, and update at least one diffusion model conditioned on three-dimensional (3D) data associated with two-dimensional (2D) images.

The processors, systems, and/or methods described herein can be implemented by or included in at least one a system. The system can include a system for performing gaming. The system can include a system for performing content streaming. The system can include a system for performing collaborative content creation. The system can include a system for performing simulation operations. The system can include a system for performing collaborative content creation for 3D assets. The system can include a system for generating synthetic data. The system can include a system including one or more vision language models (VLMs). The system can include a system including one or more large language models (LLMs). The system can include a system for performing conversational AI operations. The system can include a system for performing light transport simulation. The system can include a system for performing deep learning operations. The system can include a system for performing digital twin operations. The system can include a control system for an autonomous or semi-autonomous machine. The system can include a perception system for an autonomous or semi-autonomous machine. The system can include a system incorporating one or more virtual machines (VMs). The system can include a system implemented using a robot. The system can include a system implemented using an edge device. The system can include a system implemented at least partially in a data center. The system can include a system implemented at least partially using cloud computing resources. The system can include a system for generating interactive 3D visualizations. The system can include a system implemented at least partially using augmented reality (AR) or virtual reality (VR) platforms.

### BRIEF DESCRIPTION OF THE DRAWINGS

The present systems and methods for 3D scene reconstruction using VoxSplats representation are described in detail below with reference to the attached drawing figures, wherein:

FIG. 1 is a block diagram illustrating an example of a 3D scene reconstruction system including a generative geometry network and an appearance network for reconstructing 3D scenes using one or more input images, in accordance with some embodiments of the present disclosure;

FIG. 2 illustrates examples of the input images, in accordance with some embodiments of the present disclosure;

FIG. 3 is a flowchart diagram illustrating an example method for determining an input feature cube for input images during deployment, in accordance with some embodiments of the present disclosure;

FIG. 4A illustrates an example of sparse voxel grid, in accordance with some embodiments of the present disclosure;

FIG. 4B illustrates an example of sparse voxel grid, in accordance with some embodiments of the present disclosure;

FIG. 5 is a diagram illustrating input images, VoxSplats, and output novel views generated using the 3D scene reconstruction system of FIG. 1, in accordance with some embodiments of the present disclosure;

FIG. 6 is a flowchart diagram illustrating an example method for generating a novel view using the 3D scene reconstruction system of FIG. 1, in accordance with some embodiments of the present disclosure;

FIG. 7 is a block diagram illustrating an example of training the generative geometry network of FIG. 1, in accordance with some embodiments of the present disclosure;

FIG. 8 is a flowchart diagram illustrating an example method for curating a training dataset for training the generative geometry network of FIG. 1, in accordance with some embodiments of the present disclosure;

FIG. 9A illustrates an example 3D representation after accumulating the training 3D data over a period of time, in accordance with some embodiments of the present disclosure;

FIG. 9B illustrates an example 3D representation after MVS algorithm is applied, in accordance with some embodiments of the present disclosure;

FIG. 9C illustrates an example 3D representation after point samples for dynamic objects are added, in accordance with some embodiments of the present disclosure;

FIG. 10 is a flowchart diagram illustrating an example method for training (e.g., updating) the generative geometry network of FIG. 1, in accordance with some embodiments of the present disclosure;

FIG. 11A is an illustration of an example autonomous vehicle, in accordance with some embodiments of the present disclosure;

FIG. 11B is an example of camera locations and fields of view for the example autonomous vehicle of FIG. 11A, in accordance with some embodiments of the present disclosure;

FIG. 11C is a block diagram of an example system architecture for the example autonomous vehicle of FIG. 11A, in accordance with some embodiments of the present disclosure;

FIG. 11D is a system diagram for communication between cloud-based server(s) and the example autonomous vehicle of FIG. 11A, in accordance with some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

The embodiments described herein relate to predicting a set of Gaussian Splats in a three dimensional volume (VoxSplat) from input images using a feed-forward process, including using a generative geometry network to predict a sparse voxel hierarchy (corresponding to a 3D scene) conditioned on the input images and using an appearance network to predict the Gaussian attributes within the voxels and a skybox texture to represent the background for rending a novel view of the 3D scene. A feed-forward network does not require a long optimization or differentiation with respect to the input images and scene representation. The scene prior is learned in truth 3D space. The generative geometry network and the appearance network are implemented using highly efficient sparse convolution architectures for 3D data to allow reconstruction of a full scene from input images in under tens of seconds.

In at least one embodiment, both the generative geometry network and the appearance network are trained or updated directly over a curated 3D dataset, which is represented by the sparse voxel hierarchy. By learning the sparse voxel hierarchy that defines the entire scene modeled in a 3D space and the data priors, the methods described herein can learn the relationship between occluded portions of the scene and the non-occluded portions of the scene. Thus, a 3D representation can be generated without being impacted by occlusion and has regularized geometry, unlike traditional approach such as a depth map unprojected approach.

In some arrangements, the 3D scene reconstruction pipeline described herein reconstructs a high-resolution 3D scene in the form of a sparse voxel hierarchy from N input sparse images

$$𝒥 = {\{ {I}^{i} \}}_{i = 1}^{N}$$

in two stages. In a first stage, scene geometry represented as a sparse voxel grid [symbol] is reconstructed with semantic features. Semantic features relate to the classification of objects in connection to a given voxel in the sparse voxel grid [symbol] . In a second stage, appearance [symbol] of the scene is predicted based on the sparse voxel grid [symbol] to allow for high-quality novel view synthesis using VoxSplats and an image (or a composite image, such as a panorama) of a static region of the scene, such as a sky. The 3D scene reconstruction pipeline can be expressed as taking samples from distribution p( [symbol] , [symbol] | [symbol] )=p( [symbol] | [symbol] , [symbol] )p( [symbol] | [symbol] ). To further improve the final view quality of the novel view, in some examples, post-processing using a Generative Adversarial Network (GAN) can be applied.

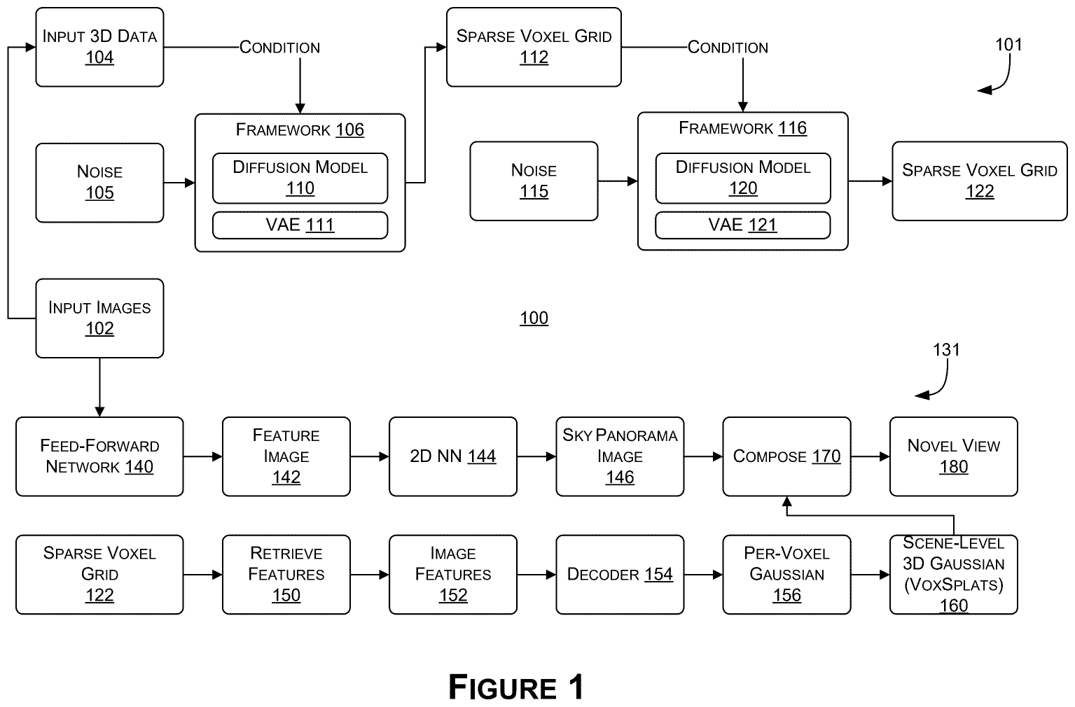

FIG. 1 is a block diagram illustrating an example of a 3D scene reconstruction system 100, implemented as a pipeline that includes a generative geometry network 101 (e.g., a first network) and an appearance network 131 (e.g., a second network) for reconstructing 3D scenes using one or more input images 102, according to various embodiments. It should be understood that this and other embodiments described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, a function described herein can be carried out by at least one processor executing instructions stored in at least one memory.

The generative geometry network 101 (system, pipeline, stage and so on) reconstructs a sparse voxel hierarchy and is referred to as a voxel grid reconstruction stage. The end goal for the generative geometry network 101 is to reconstruct the sparse voxel grids 112 and 122 (e.g., the sparse voxel hierarchy) from one or more input images 102 and input 3D data 104. Outdoor scenes are often large in scale and contain complicated internal structures, causing certain memory inefficiency representations such as tri-planes, dense voxel grids, or meshes to fail due to capacity or memory limitations. Optimization-based reconstruction methods use high-resolution hash grids which are challenging to infer using a neural network. In contrast, sparse voxel grids are effective for learning scene-reconstruction as sparse voxel grids are efficient sparse neural operators.

The input images 102 can include any two dimensional (2D) data (e.g., images or frames of a video) of an environment or scene, such as open air data image sets, indoor scenes image set (e.g., warehouse scene, home scene, etc.), outdoor scenes image sets, underground or tunnel image sets, aerial image sets, and so on. In some implementations, each input image 102 is captured using a camera located on a vehicle (e.g., an autonomous vehicle described herein), robot, augmented reality headset, etc. Examples of a dataset of the input images 102 include the Waymo Open Dataset. Such input images 102 can be referred to as sparse-view images. The training and deployment pipelines described herein are supported on sparse-view images, thus significantly shifting the input requirements for both training and deployment away from large datasets.

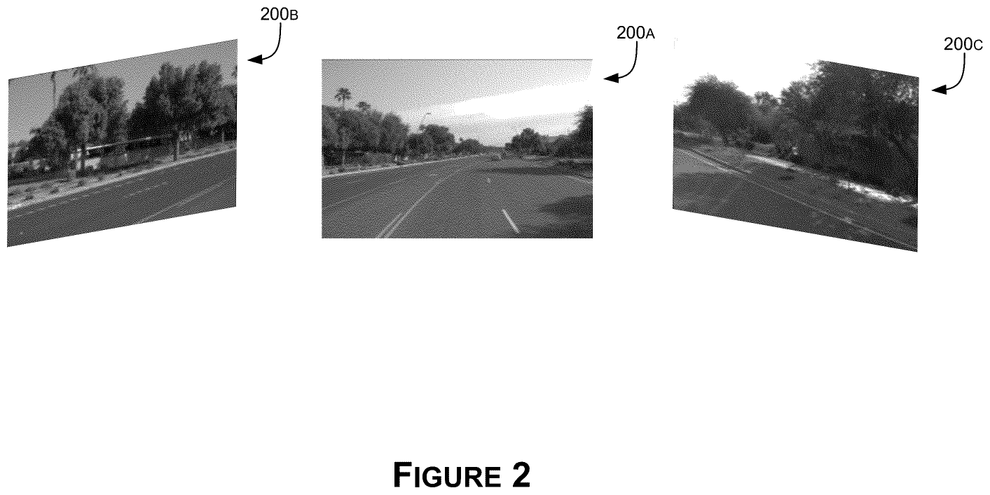

FIG. 2 illustrates examples 200a, 200b, and 200c of the input images 102, according to some embodiments. In some embodiments, a vehicle can include a plurality (e.g., 3 or 5) of outward facing cameras, one or more (e.g., each) with a different pose (position and orientation) to capture images 200a, 200b, and 200c of the environment around the vehicle. In at least one embodiment, there may be no overlap between the images 200a, 200b, and 200c captured by the different cameras. As shown, the image 200a can be captured by a front facing camera, the image 200b can be captured by a front-left facing camera, and the image 200c can be captured by a front-right facing camera. The images 200a, 200b, and 200c can be captured at the same timestamp or time step. Unlike inward facing views, project features directly along the rays from images of outward facing views (without conditioning as described herein) fails to provide an accurate 3D representation of the scene due to lack of guidance on the geometry. In some examples, the images 200a, 200b, and 200c are non-overlapping. In other examples, the area overlap of two of the images 200a, 200b, and 200c is less than 10%.

As described herein, the input images 102 can be lifted into 3D representations through depth prediction to provide the networks with additional information on the geometry of the scene, thus allowing a more accurate reconstruction of the scene. In other words, the input 3D data 104 on which the diffusion model 110 is conditioned includes a 3D representation (e.g., an input feature cube) that is determined using the input images 102.

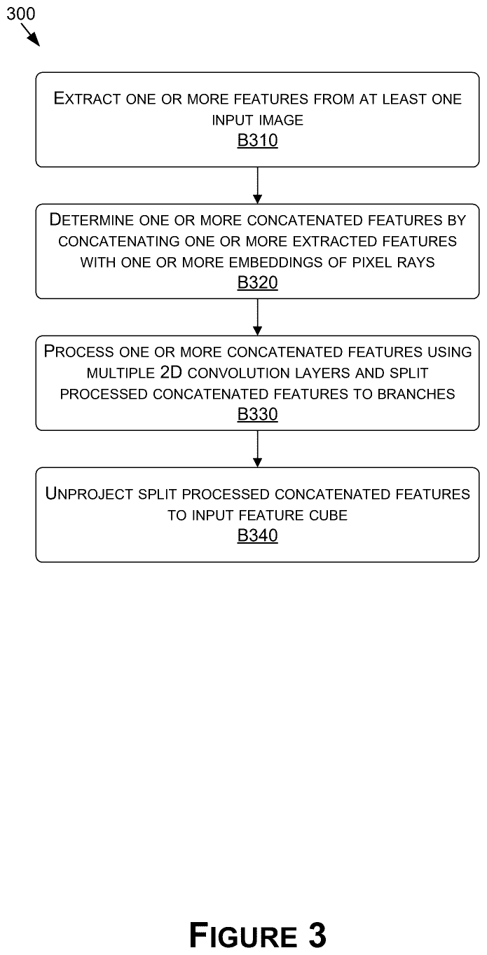

FIG. 3 is a flowchart diagram illustrating an example method 300 for determining an input feature cube for input images during deployment, according to some embodiments. Each block of method 300, described herein, includes a computing process that may be performed using any combination of hardware, firmware, and/or software. For instance, various functions may be carried out by at least one processor executing instructions stored in at least one memory. The method 300 may also be embodied as computer-usable instructions stored on one or more computer storage media. The method 300 may be provided by a standalone application, a service or hosted service (standalone or in combination with another hosted service), or a plug-in to another product, to name a few. In addition, the method 300 is described, by way of example, with respect to the system of FIG. 1. However, this method may additionally or alternatively be executed by any one system, or any combination of systems, including, but not limited to, those described herein.

In the method 300, to determine the 3D representation of the scene from at least one input image (e.g., the input images 102), one or more features (e.g., useful semantic information) are extracted from the input images 102, and the one or more extracted features of the input images 102 are unprojected into the input feature cube. In some embodiments, at B310, features are extracted from at least one input image 102. In some examples, the features can include universal features (e.g., DINO-v2 features) obtained from a model such as a self-supervised vision transformer model. The self-supervised vision transformer model extracts features from an image and forms a feature map corresponding to the input image 102. The features reflecting geometry can be extracted for each patch (one or more pixels) of the input image 102. The appearance of such features can include 3D relationship among the features and semantic information, which can be learned through self-supervision.

In some embodiments, a Lift, Splat, Shoot (LSS) approach can be implemented to unproject the extracted features of the input images 102 into the input feature cube. For example, all voxels of the input feature cube along one or more rays from at least one (e.g., each) pixel of the input images 102 can be ray traced, and at least one (e.g., each) voxel along a ray is assigned an extracted feature of at least one input image 102. The features of all voxels are modulated along the same ray by the weight computed from the depths. Therefore, the closer an object is to an actual depth of that pixel, the larger the feature corresponding to the object. This informs the distance an object is from the from the actual geometry.

In other words, the features computed on the input images 102 can be lifted from 2D to 3D. For example, at B320, the one or more extracted features can be concatenated with one or more embeddings computed from coordinates such as Plücker coordinates (e.g., Plücker embeddings) of pixel rays from pixels of the input images to obtain one or more concatenated features. Plücker embeddings can be used to encode the pixel rays, each pixel ray can be defined based on a region and a direction. The concatenated features can inform the network that the extracted features for a given pixel are mapped to a coordinate in the 3D space.

At B330, the one or more concatenated features are processed using multiple 2D convolution layers and then split into two branches for each pixel j and image Iⁱ. One branch produces a feature

$${F}_{j}^{i}$$

(e.g., a regular C-dimensional feature) and the other branch generates a vector

$${θ}_{j}^{i}$$

ϵ [symbol] ^{D} (e.g., a D-dimensional Softmax-normalized vector). In some examples,

$${θ}_{j}^{i}$$

can be a distribution over the depth of the corresponding pixel. At B340, the split processed concatenated features are unprojected to the input feature cube to generate the condition for the diffusion model 110. For example, the input images 102 are unprojected into a 3D sparse voxel grid Ω (e.g., the sparse voxel grid 122), where v denotes the index of a voxel and dϵ[1,D] indexes the depth buckets. An example expression (1) corresponding to this process for determining a conditioning C is shown below:

$${F}_{j d}^{i} = {θ}_{j d}^{i} \cdot {F}_{j}^{i} , {C}_{v} = {\sum }_{( i , j , d )} {F}_{j d}^{i} ∈ {ℝ}^{C} . \qquad ( 1 )$$

The depth can be quantized into D bins, equally dividing the range from a predefined [symbol] to a predefined [symbol] . Unlike image-conditioning techniques used in object-level or indoor-level datasets where the camera frusta have significant overlap, the input images 102 can include low-overlapping or non-overlapping views captured from at least one ego-centric camera (e.g., cameras of a vehicle). The use of the weight θ allows occlusions to be effectively addressed, and a conditioning signal with improved accuracy can be obtained. In some examples, C is concatenated with latent X of the diffusion model 110/120 or the Variational Autoencoder (VAE) 111, the result of which is fed it into a latent diffusion framework 106/116 (e.g., the diffusion model 110) as conditioning. C is a condition imposed on the diffusion model 110/120 through concatenating C with the latent X, which is a variable produced by the diffusion model 110/120 during its training and testing.

In some embodiments, a latent diffusion framework (e.g., XCube) includes the diffusion models 110 and 120 (e.g., voxel latent diffusion models). The latent diffusion framework includes a 3D generative model that generates high-quality samples for both objects and scenes. The latent diffusion framework uses a hierarchical latent diffusion model (e.g., the models 110 and 120) to generate a hierarchy of sparse voxel grids 112 and 122 where each finer voxel (e.g., each voxel in the sparse voxel grid 122) is contained within a corresponding coarser voxel (e.g., a voxel in the sparse voxel grid 112). In some examples, the diffusion models 110 and 120 are the same model, and the generative geometry network 101 as shown runs the same diffusion model 110/120 twice with different noise and conditions.

The latent diffusion framework 106/116 learns a distribution over latent X encoded by a VAE 111/121. In some examples, at least one (e.g., each) of the frameworks 106 and 116 includes a latent diffusion model 110 or 120 and a VAE structure. The framework 106 includes the diffusion model 110 and a VAE 111. The framework 116 includes the diffusion model 120 and a VAE 121. Both frameworks 106 and 116 (e.g., both the VAEs 111 and 121 and the diffusion models 110 and 120) can be instantiated with sparse convolutional neural networks. In some cases, the VAEs 111 and 121 and the diffusion models 110 and 120 can generate geometry at high (e.g., 10243) resolution. Examples of the diffusion models 110 and 120 include diffusion UNet. Examples of the VAEs 111 and 121 include sparse structure VAE.

In a latent diffusion framework, a 3D scene is encoded into latent space, and a diffusion model 110 or 120 is applied on the latent space. A noise 105 (e.g., random Gaussian noise) and the condition C from the input feature cube are encoded into the latent diffusion model 110 (e.g., the VAE 111), which outputs the sparse voxel grid 112. The sparse voxel grid 112 includes coarser level voxels (e.g., at a resolution of 2563). The sparse voxel grid 112 is used to condition the latent diffusion model 120. For example, a noise 115 (e.g., random Gaussian noise) and the condition of the sparse voxel grid 112 are encoded into the latent diffusion model 120 (e.g., the VAE 121) which outputs the sparse voxel grid 122 to upsample the resolution of the sparse voxel grid 112 to a higher resolution. The sparse voxel grid 122 includes finer level voxels (e.g., at a resolution of 10243). In some examples, the latent diffusion models 110 and 120 are the same model, such that the noise 115 and the condition of the sparse voxel grid 112 are encoded into the latent diffusion model 110 which outputs the sparse voxel grid 122.

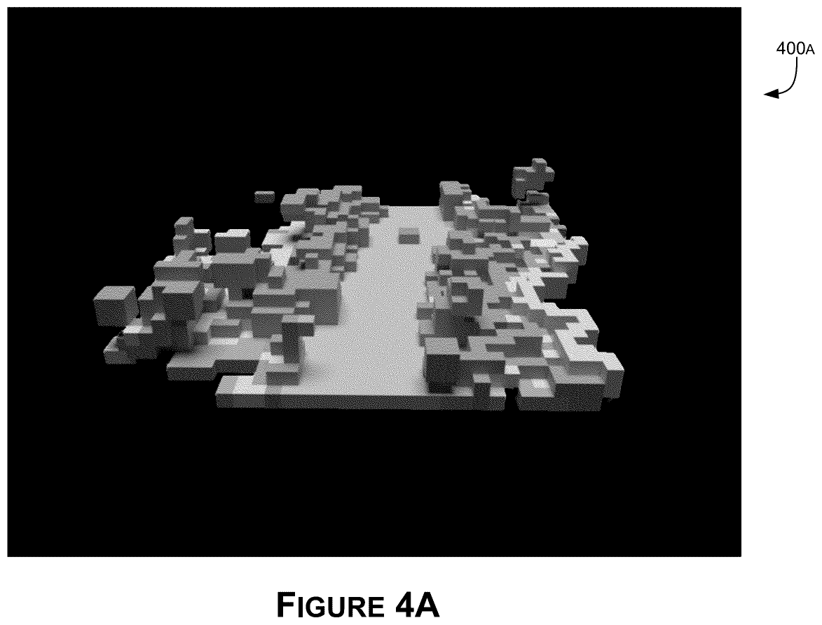

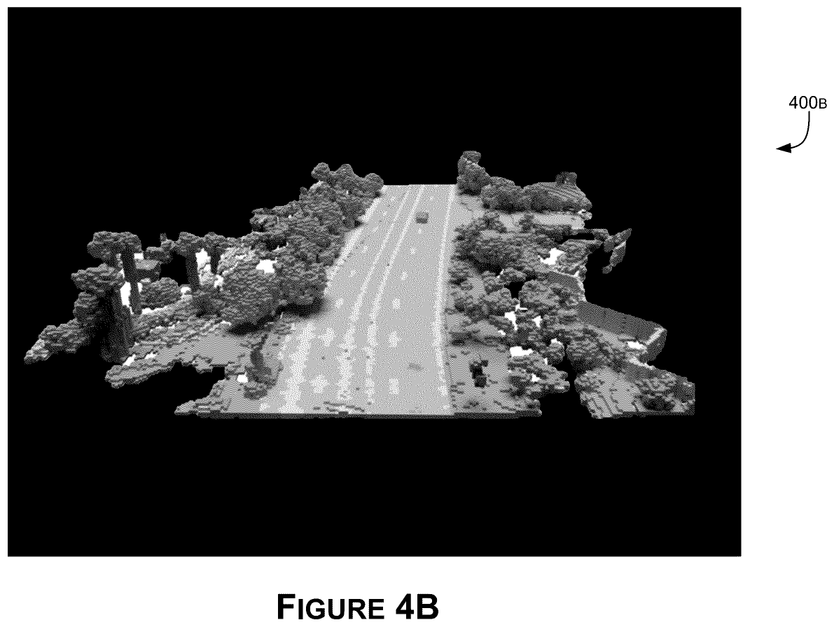

In one or more embodiments, at least one (e.g., each) of the voxel grids 112 and 122 includes 3D voxels. The voxel grids 112 and 122 are sparse given that most (e.g., greater than 50%, 75%, 50%, 90%, or 95%$) of the regions of the voxel grids 112 and 122 are unoccupied as only existing regions with objects need to be reconstructed. FIG. 4A is a visualization of an example of sparse voxel grid 112, according to some embodiments. FIG. 4B is a visualization of an example of sparse voxel grid 122, according to some embodiments. Each voxel in the sparse voxel grid 112 contains at least one or multiple voxels in the sparse voxel grid 122.

The appearance network 131 modifies (e.g., corrects) the voxel grid 122 generated from the generative geometry network 101 and predicts a set of VoxSplats (e.g., scene-level 3D Gaussians or Gaussian splats) in at least one (e.g., each) voxel to model the scene appearance. In some examples, the goal of appearance reconstruction by the appearance network 131 is to assign at least one (e.g., each) voxel in the sparse voxel grid 122 (e.g., fine-level voxels) at least one Gaussian to reflect the appearance (e.g., RGB values) of the scene.

At 150, image features 152 corresponding to the sparse voxel grid 122 are retrieved from the input images 120. For example, the voxels in the sparse voxel grid 122 are reprojected back onto the input images 120. Latent image features 152 are queried from at least one (e.g., each) voxel of the sparse voxel grid 122, and one or more latent image features 152 corresponding to the voxels of the sparse voxel grid 122 are gathered. In some examples, the sparse voxel grid 122 can query the image features 152 according to projections of the image features 152 on the image plane. In some examples, at least one (e.g., each) voxel of the sparse voxel grid 122 is positionally encoded and then the positional encoding of at least one (e.g., each) voxel is concatenated with the corresponding image feature 142.

In some embodiments, (M×14)-dimensional vector {[|μ̅ᵥ,α̅ᵥ,s̅ᵥ,q̅ᵥ,RGBᵥ]}M is predicted for at least one (e.g., each) voxel of the sparse voxel grid 122 via a 3D sparse convolutional U-Net, which processes the features 152 queried from 150. The 3D sparse convolutional U-Net takes as input the sparse voxel grid 122 outputted by the generative geometry network 101. At least one (e.g., each) voxel of the sparse voxel grid 122 contains a feature sampled from the input images 102. In some examples, at least one (e.g., each) input image Iⁱ is processed using a convolutional neural network (CNN), and a ray is casted from at least one (e.g., each) image pixel into the sparse voxel grid 122, accumulating the feature in the first voxel of the sparse voxel grid 122 intersected by that ray. In an example workflow, the CNN is used to process the features 152 of the input images 102. Then, the features 152 are retrieved from the input images 102 to the sparse voxel grid 122. Next, the 3D sparse convolutional U-Net processes the sparse voxel grid 122 with the features 152, which output the Gaussian attributes (e.g., the per-voxel Gaussians). Voxels of the sparse voxel grid 122 that are not intersected by any rays receive a zero feature vector.

The one or more gathered latent features 152 are decoded by a decoder 154 for at least one (e.g., each) voxel in the sparse voxel grid 122 to obtain at least one Gaussian attribute (e.g., per-voxel Gaussian 156). When decoding the image features 152 from at least one (e.g., each) voxel, the positions of the Gaussians are constrained within the voxels so that the shapes of the Gaussian can fit into the sparse voxel hierarchy (e.g., the sparse voxel grids 112 and 122) without being overly far from the actual voxel. In one or more embodiments, at least one of the one or more Gaussian attribute includes at least one of position, rotation, scaling, opacity, color, and so on, that define the appearance of a voxel. At least one of the one or more Gaussian attributes are regressed to determine or predict the scene-level 3D Gaussian, referred to as VoxSplats, to be rendered as the novel view 180.

Gaussian splatting is a 3D representation technique that models a scene's appearance volumetrically as sum of Gaussians G(s), such as:

$$G ( x ) = RGB \cdot α \cdot {e}^{- \frac{1}{2} ( x - μ ) {T}_{\sum } - 1 ( x - μ )} , \qquad ( 2 )$$

where aϵ[0, 1] is the opacity, μϵ [symbol] ³ is the center of each Gaussian, and Σ=RSS^{T}R^{T} ϵ [symbol] ^{3×3} is its covariance. The covariance matrix is factorized into a rotation matrix R parameterized by a quaternion q and a scale diagonal matrix S=diag(s). At least one (e.g., each) Gaussian can, in one or more embodiments, additionally store a color value RGB. A set of 0^{th}-order spherical harmonics (SH) coefficients (without view-dependency) are applied to the Gaussians, which is sufficient for sparse-view reconstruction (no view dependency needed) and thus conserves computational resources and time.

Instead of heuristics to optimize the positions of Gaussians for a given scene, at least one Gaussian (e.g., M Gaussians) is predicted per-voxel using a feed-forward model. The positions of the Gaussians are limited to lie within a neighborhood of the supporting voxels of the positions, thus preserving the geometric structure of the supporting grid. By grounding the splats on a voxel scaffold (e.g., the sparse voxel grid 122), improved geometric quality can be achieved in one pass without resorting to heuristics. Voxel-supported Gaussian splats are referred to as VoxSplats herein.

In some examples, per-voxel Gaussian 156 (e.g., per-voxel Gaussian attribute(s)) can be defined as {[|μ̅ᵥ,α̅ᵥ,s̅ᵥ,q̅ᵥ,RGBᵥ]ϵ [symbol] ¹⁴} for each voxel v. μ̅ᵥ is the position (e.g., defined by a coordinate) for each voxel. α̅ᵥ is the opacity or transparency for each voxel. s̅ᵥ is the scaling in each dimension for each voxel. q̅ᵥ is the rotation for each voxel. To compute the per-Gaussian parameters used for rendering, the following activations can be applied:

$${μ}_{v} = r \cdot tanh {\overline{μ}}_{v} + {Center}_{v} , {α}_{v} = sigmoid ( {\overline{α}}_{v} ) , {s}_{v} = exp {\overline{s}}_{v} , {R}_{v} = q uat 2 rot ( {\overline{q}}_{v} ) , \qquad ( 4 )$$

where Centerᵥ is the centroid of the voxel v, and r is a hyperparameter that controls the range of a Gaussian within its supporting voxel. A supporting voxel of a Gaussian refers to a voxel that generates that Gaussian splats. In some examples, r can be set to three times the voxel size. The Gaussians can be efficiently predicted using rasterization or raytracing. Gaussian splatting enables real-time neural rendering and can be applied to overfitting large scenes. Accordingly, VoxSplat allows reconstruction in a direct inference pass as due to the efficiency of sparse grids and the high representation power of Gaussian splats. Furthermore, by operating only on sparse-view images, burdensome input requirements for learning is lifted.

In one or more scenarios or scenes, there may be distant scene portions or distant geometry (e.g., sky mask) that is far away from the observer or from the viewpoint or camera pose at which the novel view 180 is to be rendered. In some examples, the distant scene portion is considered to have an infinite depth of distance away from the observer, which in a scene is roughly defined as 100 m by 100 m by 100 m. The reconstruction of the near scene portion or near geometry in VoxSplat is achieved using the 3D generative geometry network 101, and the distant scene portion is constructed using the 2D neural network (including the sky feed-forward network 140 and the 2D neural network 144). The 2D neural network and the 3D network are separated based on a rendered grid mask. In some examples, by unprojecting the point cloud onto the images, a mask corresponding to the distant scene portion is automatically obtained, and the mask can be used to separate the distant scene portion from the near scene portion.

In some embodiments, a feed-forward network 140 extracts features from the input images 120 and unproject the pixels of the input images 120 onto a composite image (e.g., a panorama feature image 142). The panorama feature image 142 is fed through a 2D neural network 144 to obtain attributes (e.g., RGB values) of the sky panorama image 146 (e.g., a 360° image). To capture appearance away from the predicted geometry, the feed-forward network 140 and the neural network 144 predict a sky-panorama L (e.g., sky panorama image 146), which is a feature image where each pixel corresponds to a direction on a sphere.

The VoxSplats 160 (3D Gaussian splats) and the sky panorama image 146 are composed at 170 to form a novel view 180 from any viewpoint (e.g., a camera pose). The composition of the VoxSplats 160 and the sky panorama image 146 can be achieved through alpha compositing, whereby VoxSplats 160 are rendered from the viewpoint, and the sky panorama image 146 is rendered from the viewpoint, and rendered 2D images are aggregated or combined to form the novel view 180. In some examples, a novel view image I_{pred} rendered from camera pose using the system can be expressed as:

$${I}_{pred} ( u , v ) = {I}_{G S} ( u , v ) + ( 1 - T ( u , v ) ) \cdot L ( Ψ ( u , v , ξ ) ) , \qquad ( 5 )$$

where Ψ(⋅,⋅,⋅) transforms the pixel coordinate (u, v) into a ray direction vector in the world coordinate frame given by camera pose ξ, I_{GS}(u, v) is the rendered Gaussian splat image (rendered from the VoxSplats 160), T(u, v) is the accumulated transmittance map of the Gaussians, and L(ΨF(u, v, ξ) represents the distant scene portion of the novel view image rendered from the camera pose ξ.

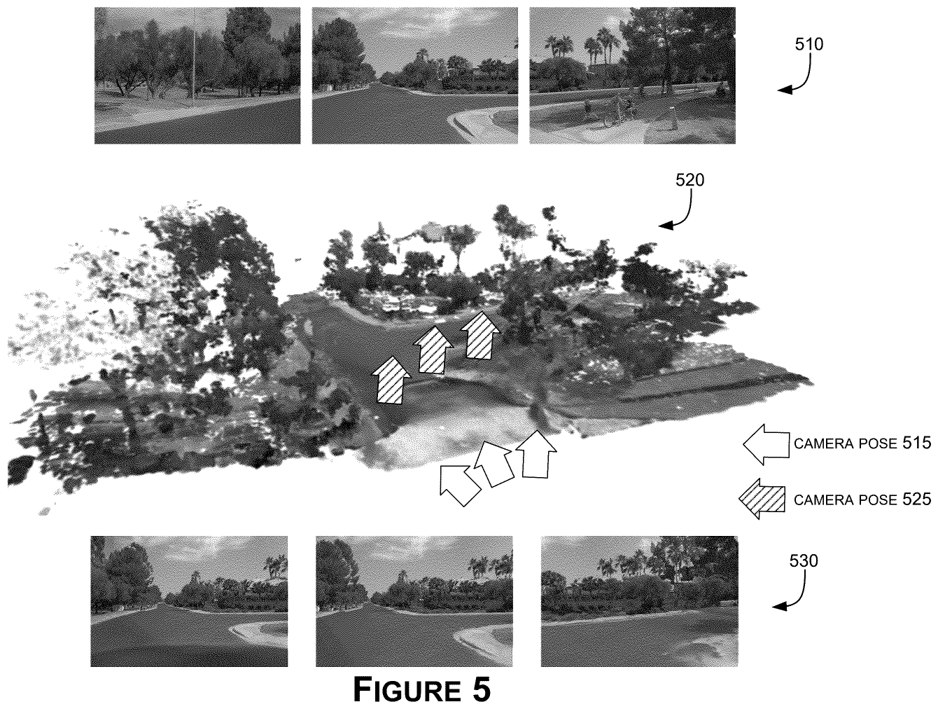

FIG. 5 is a diagram illustrating input images 510, VoxSplats 520, and output novel views 530 generated using the 3D scene reconstruction system 100, according to some embodiments. The input images 510 are examples of the input images 102. The input images 510 are captured by cameras at the camera poses 515, respectively. The novel views 530 are examples of the novel views 180. The novel views are rendered from the camera poses 525 (e.g., camera poses), respectively. As described, the generative geometry network 101 and the appearance network 131 can generate the VoxSplats 520, which can be rendered and combined with rendered view from the sky panorama image 146 to compose the novel views 530.

In some embodiments, the novel view 180 can be applied to a Generative Adversarial Network (GAN) for postprocessing. In some cases, the novel views 180 directly rendered from the appearance network 131 may suffer from voxelization artifacts or noise. To address such issues, lightweight conditional GAN that takes the rendered novel view 180 as input and outputs a refined version of the novel view 180. In some examples, a discriminator of the GAN takes 256-by-256 image patches sampled from the input images 102 and the generated novel view 180, conditioned on the rendered images (e.g., the novel view 180). The GAN is independently fitted for each scene at inference time. In some examples, GAN is applied when higher-quality novel view 180 images are needed.

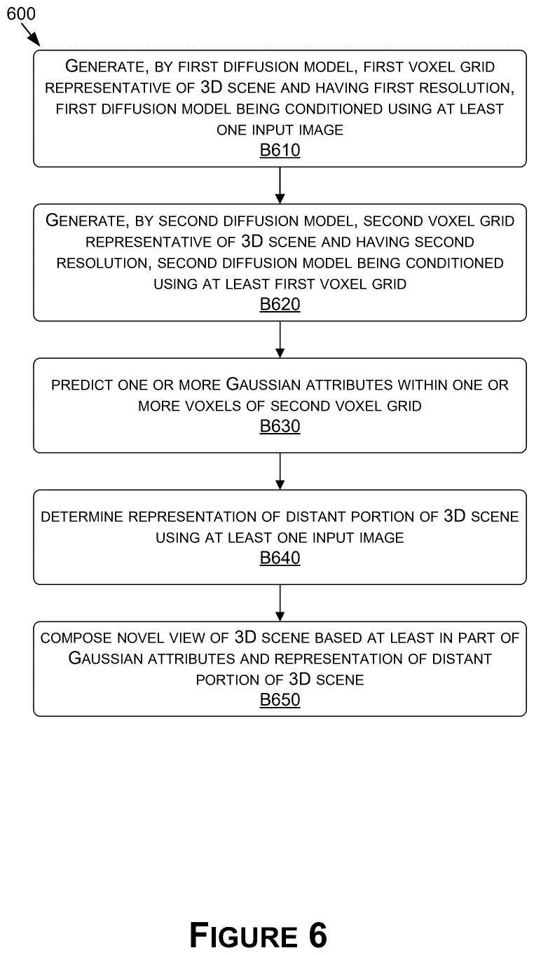

FIG. 6 is a flowchart diagram illustrating an example method 600 for generating a novel view 180, according to various embodiments. Each block of method 600, described herein, includes a computing process that may be performed using any combination of hardware, firmware, and/or software. For instance, various functions may be carried out by at least one processor executing instructions stored in at least one memory. The method 600 may also be embodied as computer-usable instructions stored on one or more computer storage media. The method 600 may be provided by a standalone application, a service or hosted service (standalone or in combination with another hosted service), or a plug-in to another product, to name a few. In addition, the method 600 is described, by way of example, with respect to the system of FIG. 1. However, this method may additionally or alternatively be executed by any one system, or any combination of systems, including, but not limited to, those described herein.

At B610, a first voxel grid representative of a 3D scene and having a first resolution is generated by a first diffusion model (e.g., the diffusion model 110), the first diffusion model is conditioned using at least one input image 102. At B620, a second voxel grid representative of the 3D scene and having a second resolution is generated by a second diffusion model (e.g., the diffusion model 120), the second diffusion model is conditioned using the first voxel grid. In some examples, the second resolution is greater than the first resolution. The first voxel grid and the second voxel grid are a voxel grid hierarchy representing a 3D scene. At B630, one or more Gaussian attributes (e.g., the Gaussian 156) are predicted within one or more voxels of the second voxel grid. At B640, a composite representation of a distant portion of the 3D scene, such as a sky panorama (e.g., the sky panorama image 146) is determined using the at least one input image 102. At B650, a novel view 180 of the 3D scene is composed (e.g., at 170) based at least in part on the one or more Gaussian attributes and the distant portion of the 3D scene (e.g., the sky panorama image 146). In other words, the distant portion of the 3D scene corresponds to a sky, the representation of the distant portion of the 3D scene includes a composite representation.

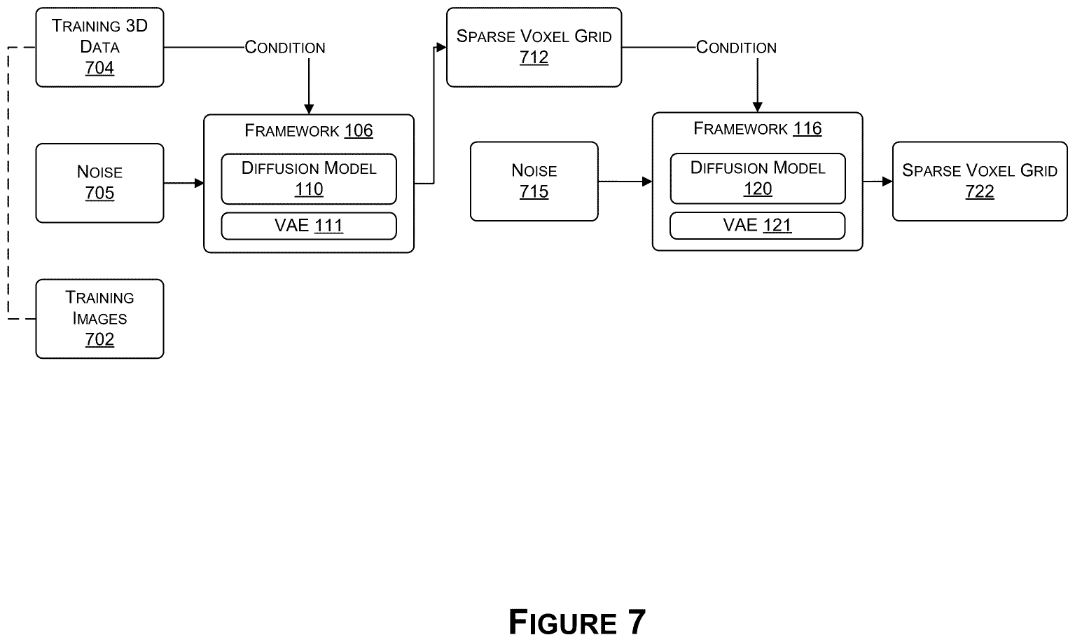

FIG. 7 is a block diagram illustrating an example of training the generative geometry network 101, according to various embodiments. It should be understood that this and other embodiments described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, a function described herein can be carried out by at least one processor executing instructions stored in at least one memory.

A training dataset including training images 702 and training 3D data 704 can be used to train (update) the generative geometry network 101. The training images 702 can be images such as the input images 102. In addition to the training images 702, accurate 3D data such as the training 3D data 704 is needed for the networks described herein to learn useful geometry and appearance priors. Training 3D data 704 can include any 3D data of the environment or scene, such as Light Detection and Ranging (LiDAR) data, time-of-flight (ToF) data, structured light data, 3D ultrasound data, wireless 3D sensing data, and so on. The training 3D data 704 can include any 3D representation of the environment of scene extracted or extrapolated from the 3D data, such as a 3D mesh, 3D point cloud, 3D triplane, and so on. In some examples, a vehicle can include one or more LiDAR devices that capture LiDAR data of the environment around the vehicle.

In some examples, the training dataset includes the corresponding training images 702 and the training 3D data 704 captured by sensors on each of a plurality of vehicles. The vehicles are considered observers with multiple perspectives and poses. The training images 702 and the training 3D data 704 can be time-aligned (e.g., based on suitable timestamps) such that a training image 702 can be mapped to the training 3D data 704 captured at the same time by the same vehicle. Available autonomous driving datasets include both 2D images and the corresponding 3D LiDAR data. The point clouds of the 3D LiDAR data can be accumulated over time to obtain the 3D scene geometry. In some examples, LiDAR points typically do not capture regions substantially higher from the ground plane, such as tall buildings. The training 3D data 704 may also contain dynamic (non-rigid) objects that are non-trivial to accumulate.

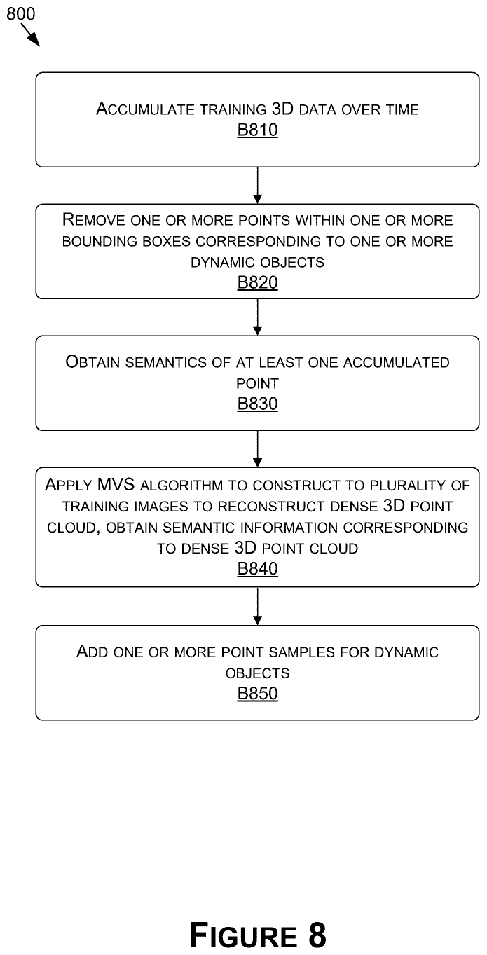

In some examples, the input dataset (including the training images 702 and the training 3D data 704) can be curated or pre-processed before being provided to the rest of the network 100 for training. FIG. 8 is a flowchart diagram illustrating an example method 800 for curating a training dataset for training the generative geometry network 101, according to various embodiments. Each block of method 800, described herein, includes a computing process that may be performed using any combination of hardware, firmware, and/or software. For instance, various functions may be carried out by at least one processor executing instructions stored in at least one memory. The method 800 may also be embodied as computer-usable instructions stored on one or more computer storage media. The method 800 may be provided by a standalone application, a service or hosted service (standalone or in combination with another hosted service), or a plug-in to another product, to name a few. In addition, the method 800 is described, by way of example, with respect to the system of FIG. 7. However, this method may additionally or alternatively be executed by any one system, or any combination of systems, including, but not limited to, those described herein.

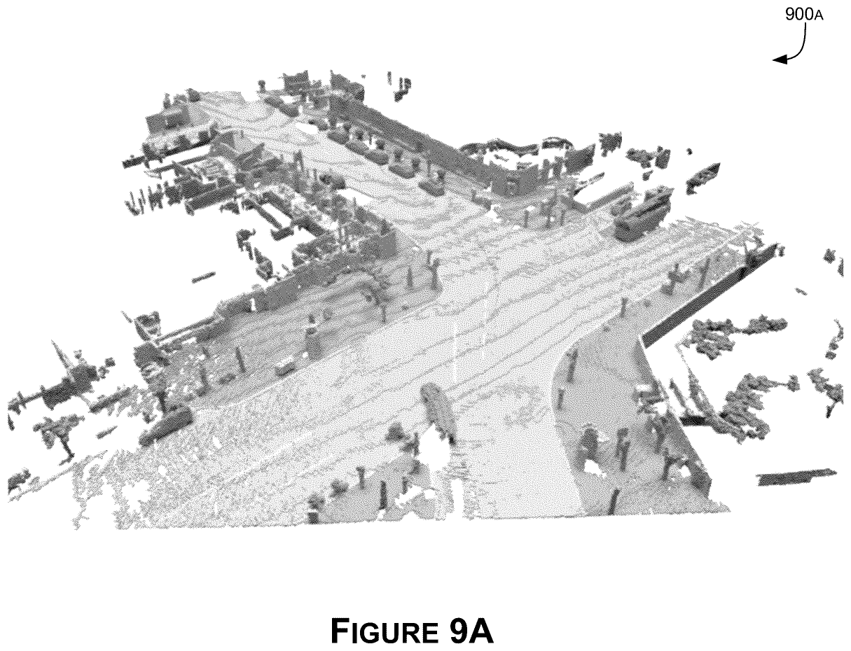

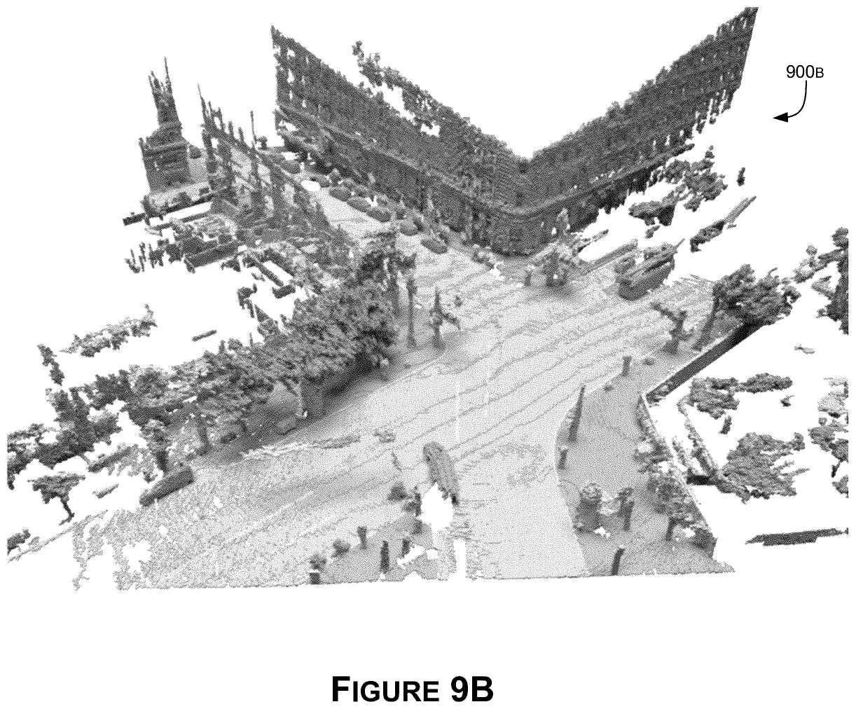

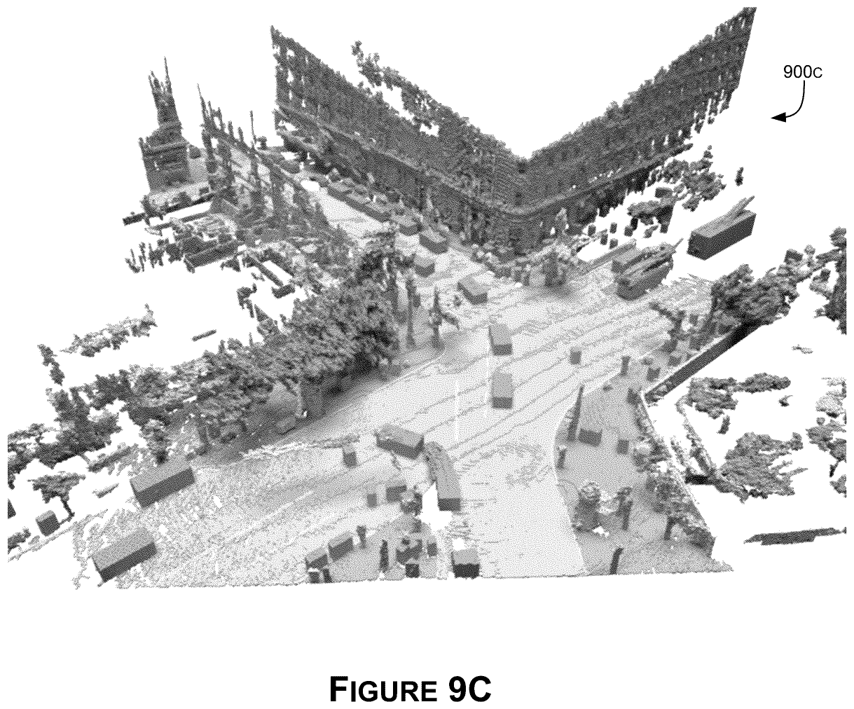

At B810, training 3D data 704 (e.g., LiDAR points) is accumulated in a world space over a period of time. The LiDAR points define the world space. In some examples, point clouds at incremental timestamps are stacked and added on top of each other, resulting in a 3D representation of an environment. FIG. 9A illustrates an example 3D representation 900a (e.g., a point cloud or grid) after accumulating the training 3D data 704 (e.g., LiDAR points) over a period of time, in some embodiments.

At B820, one or more LiDAR points within one or more bounding boxes corresponding to one or more dynamic objects such as cars and pedestrians in the world space are removed. At B830, semantics of at least one (e.g., each) accumulated LiDAR point can be obtained. Non-annotated points are assigned the semantics of their nearest annotated neighbors. At B840, a multi-view stereo (MVS) algorithm (e.g., in COLMAP) is applied to the plurality of 2D images (e.g., training images 702) to reconstruct a dense 3D point cloud from the training images 702, and the semantic information corresponding to the points in such dense 3D point cloud are obtained. For example, semantics obtained at B830 for the accumulated LiDAR points (e.g., LiDAR point cloud) is mapped to corresponding points in the dense 3D point cloud constructed using MVS, for example, using Segformer. In some examples, both the accumulated LiDAR point cloud and the dense 3D point cloud share the same set of semantic categories. The mapping can be used to convert semantic categories of the accumulated LiDAR point cloud to the semantic categories of the dense 3D point cloud, vice versa, to ensure that two point clouds share the same set of semantic categories, to allow direct merging of the accumulated LiDAR point cloud and the dense 3D point cloud. FIG. 9B illustrates an example 3D representation 900b (e.g., a dense point cloud or grid) after MVS algorithm is applied, in some embodiments. This process allows points in higher elevations with respect to the ground plane (e.g., ground level) to be added to the 3D representation.

At B850, one or more point samples for the dynamic objects are added according to the corresponding bounding boxes at a given target frame. Accordingly, the input dataset curated as such can provide static and accumulated ground truths available for training. FIG. 9C illustrates an example 3D representation 900c (e.g., a dense point cloud or grid) after point samples for dynamic objects are added, in some embodiments. The resulting 3D representation 900c is used in training and can better correspond with the aligned training images 702.

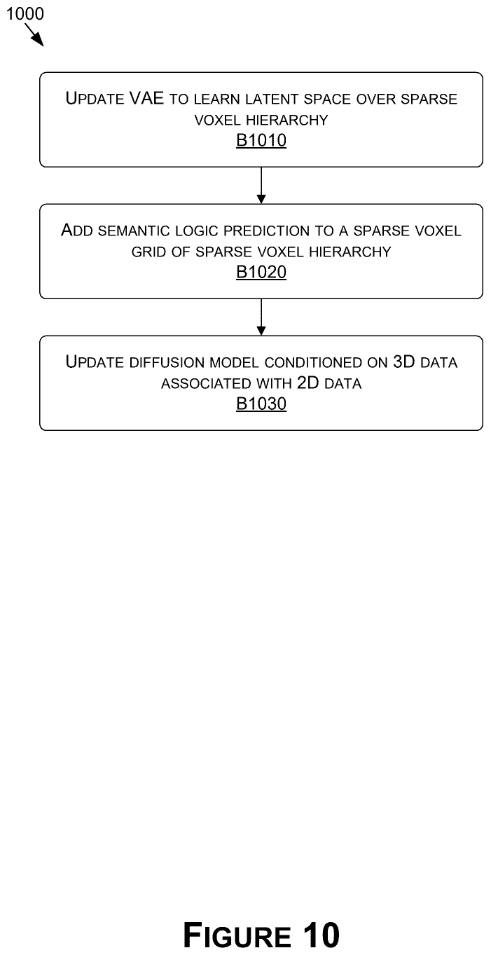

FIG. 10 is a flowchart diagram illustrating an example method 1000 for training (e.g., updating) the generative geometry network 101, according to various embodiments. Each block of method 1000, described herein, includes a computing process that may be performed using any combination of hardware, firmware, and/or software. For instance, various functions may be carried out by at least one processor executing instructions stored in at least one memory. The method 1000 may also be embodied as computer-usable instructions stored on one or more computer storage media. The method 1000 may be provided by a standalone application, a service or hosted service (standalone or in combination with another hosted service), or a plug-in to another product, to name a few. In addition, the method 1000 is described, by way of example, with respect to the system of FIG. 7. However, this method may additionally or alternatively be executed by any one system, or any combination of systems, including, but not limited to, those described herein.

At B1010, a VAE (e.g., the VAEs 111 and 121) can be updated to learn a latent space over a sparse voxel hierarchy that includes the sparse voxel grid 712 and the sparse voxel grid 722. Similar to the voxel grids 112 and 122, a noise 705 (e.g., random Gaussian noise) and the condition (e.g., the training 3D data 704 as curated using the method 800) are encoded into the latent diffusion model 110 (e.g., the VAE 111), which outputs the sparse voxel grid 712. The sparse voxel grid 712 includes coarser level voxels (e.g., at a resolution of 2563). The sparse voxel grid 712 is used to condition the latent diffusion model 120. For example, a noise 715 (e.g., random Gaussian noise) and the condition of the sparse voxel grid 712 are encoded into the latent diffusion model 120 (e.g., the VAE 121), which outputs the sparse voxel grid 722 to upsample the resolution of the sparse voxel grid 712 to a higher resolution. The sparse voxel grid 722 includes finer level voxels (e.g., at a resolution of 10243). In some examples, the latent diffusion models 110 and 120 are the same model, and the VAEs 111 and 121 are the same VAE, such that the noise 715 and the condition of the sparse voxel grid 712 are encoded into the latent diffusion model 110 which outputs the sparse voxel grid 722.

At B1020, semantic logit prediction is added to the sparse voxel grid 722 to improve learning of scene geometry. For at least one (e.g., each) voxel of the sparse voxel grid 722, a semantic prediction (e.g. whether this voxel corresponds to a certain object such as trees, roads, cars, etc.) is outputted. The semantic predictions of the voxels of the sparse voxel grid 722 can also be obtained using the VAE 121 powered by the convolution backbone (e.g., the 3D sparse convolutional U-Net). At B1030, a diffusion model (e.g., the diffusion models 110 and 120) conditioned on C (e.g., the training 3D data 704) by minimizing a loss such as:

$$ℒ = {ℒ}_{Diffusion} + {λℒ}_{Depth} , {ℒ}_{Depth} = {𝔼}_{X , i , j} Focal ( {θ}_{j}^{i} , {[ {θ}_{j}^{i} ]}_{g t} ) , \qquad ( 6 )$$

where [symbol] _{Diffusion} is the loss for the diffusion model 110 and 120. Focal(⋅) is the multi-class focal loss. This additional depth loss [symbol] _{Depth} is an explicit supervision to properly weigh the image features and encourage correct placement into the corresponding voxels of the sparse voxel grids 712 and 722. Thus, the generative geometry network 101 can learn the data prior (e.g., the training 3D data 704) to generate complete geometry even if some of the ground-truth training 3D data 704 is incomplete.

In some examples, the diffusion loss [symbol] _{Diffusion} in expression (6) can be defined with a v-parametrization, such as:

$${ℒ}_{Diffusion} = {𝔼}_{t , X , ϵ ∼ 𝒩 ( 0 , I )} [ {‖ v ( \sqrt{\overline{{α}_{t}}} X + \sqrt{1 - \overline{{α}_{t}}} ϵ , t ) - ( \sqrt{\overline{{α}_{t}}} ϵ - \sqrt{1 - \overline{{α}_{t}}} X ) ‖}_{2}^{2} , \qquad ( 7 )$$

where v(⋅) is the diffusion network, t is the randomly sampled diffusion timestamp, and α̅ₜ is the scheduling factor for the diffusion process.

For training the appearance network 131, given a set of training images 702 (e.g., training images

$${\{ {I}_{g t}^{i} \}}_{i} )$$

and sky panorama images (e.g., sky masks {Mⁱ}ᵢ) distinct from the training images 702, the appearance network 131 can be supervised by minimizing the loss:

$$ℒ = {λ}_{1} {ℒ}_{1} ( {I}_{p red}^{i} , {I}_{g t}^{i} ) + {λ}_{2} {ℒ}_{1} ( {T}^{i} , {M}^{i} ) + {λ}_{SSIM} {ℒ}_{SSIM} ( {I}_{p red}^{i} , {I}_{g t}^{i} ) + {λ}_{LPIPS} {L}_{LPIPS} ( {I}_{p red}^{i} , {I}_{g t}^{i} ) , \qquad ( 6 )$$

where the training views Iⁱ_{gt} are sampled from nearby 10 views of the training images 702. The predicted views Iⁱ_{pred} and transmittance masks Tⁱ are rendered using expression (5), and [symbol] _{LPIPS}/ [symbol] _{LPIPS} are perceptual metrics.

The building of the VoxSplats 160 and composing a novel view 180 using the sky panorama image 146 and the VoxSplats can be implemented in various systems, including autonomous driver simulations and training, text-to-scene generation, and so on. For example, LiDAR simulation can be used in autonomous vehicle simulations, training, and verification by reproducing the point cloud output given novel locations of the sensor. The generated LiDAR point clouds in the form of VoxSplats 160 accurately reflect the underlying 3D geometry. A sequence of LiDAR scans should be temporally consistent. The methods described herein enable converting sparse-view images (e.g., the input images 102) directly into LiDAR point clouds in a sensor-to-sensor conversion scheme, by leveraging the output high-resolution Gaussians (e.g., VoxSplats 160) and ray-trace the LiDAR rays to obtain the corresponding distances. Due to the voxel scaffold, the reconstructed scene is free of floaters. The opacity a can be set to 1 for all the Gaussians to ensure a hard intersection that aligns more accurate with the geometry of the scene.

With regard to text-to-scene generation. Our method can be easily extended to generate 3D scenes from text prompts. A multi-view diffusion model can be trained or updated with the architecture of vide latent diffusion models (LDMs) that generate images from text prompts. The original spatial self-attention layer is inflated along the view dimension to achieve content consistency. For training, the images can be annotated automatically on a large scale. After the model is trained, the output of the multi-view model is directly provided to the 3D reconstruction methods described herein to lift the 2D observations into 3D space for novel view synthesis.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data (e.g., the input images 102, the training images 702, and the training 3D data 704) may be used to identify regions of interest (e.g., parking spaces) and sub-regions of interest (e.g., sub-regions of a parking space that includes a curb, wheel stop, etc.) within the simulation environment, and may use this information to perform operations (e.g., parking) associated with the virtual machine within the environment. These simulated operations may be used to test performance of the underlying algorithms, systems, and/or processes (e.g., autonomous drivers) prior to deploying them in the real-world. In some instances, the simulation may be used to generate synthetic training data (e.g., the novel view 180, the VoxSplats 160, etc.)—e.g., training data including regions of interest and/or sub-regions of interest from within the simulation. The synthetic training data (in addition to or alternatively from real-world data) may then be processed to determine geometry and/or other information related to regions of interest, such as parking spaces or pallet delivery locations within a warehouse, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (based on the VoxSplats), such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

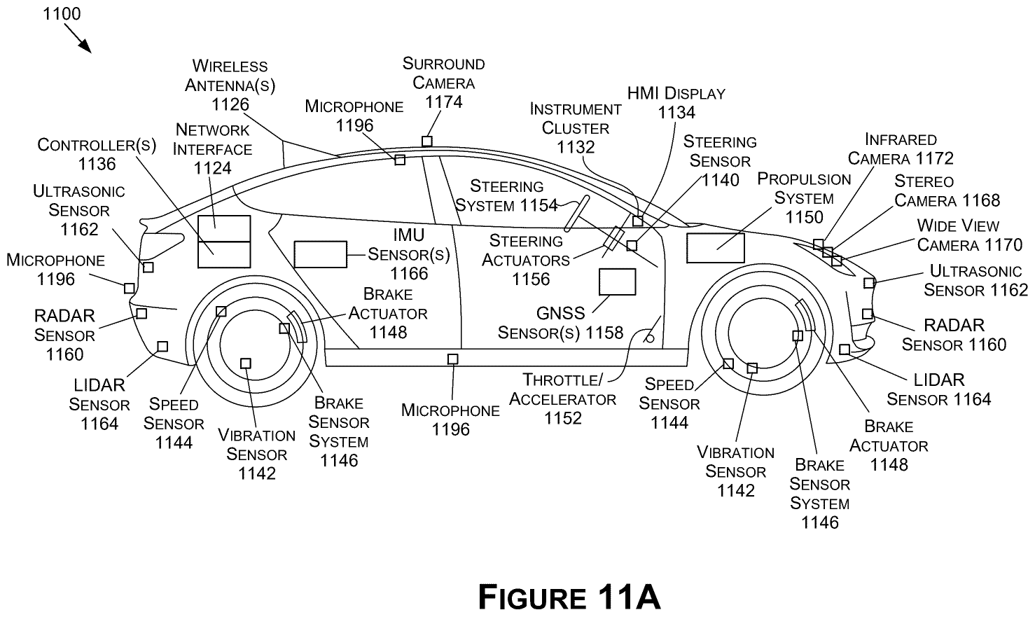

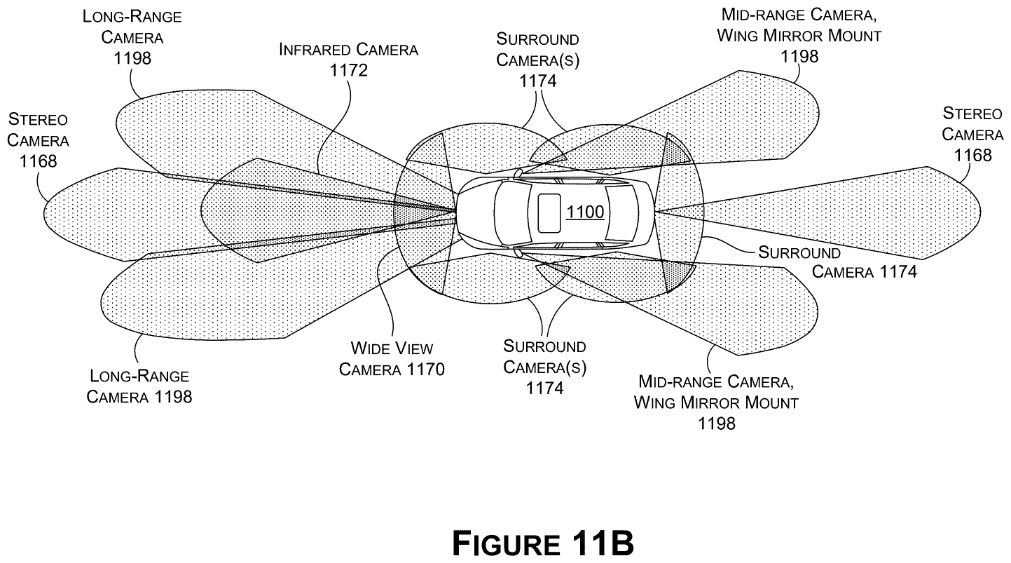

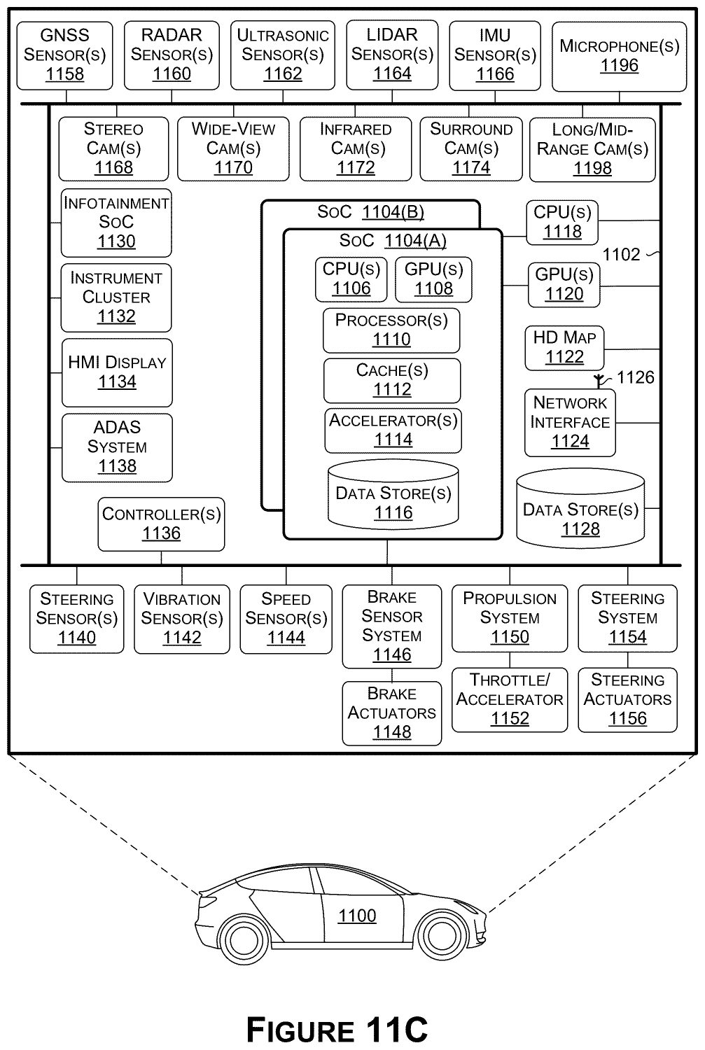

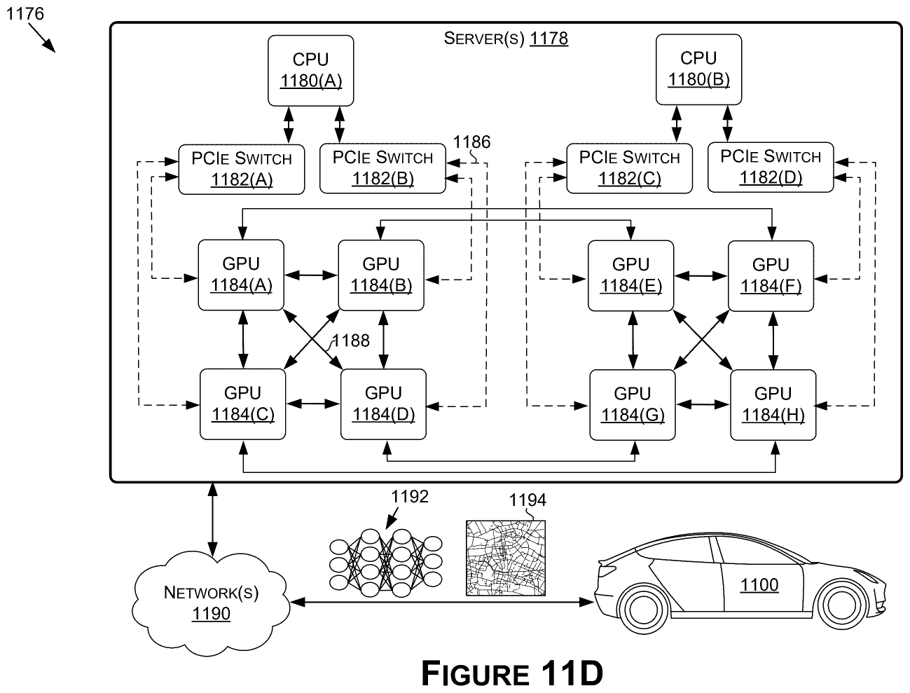

Systems and methods are disclosed related to recovering and reconstructing 3D geometry and appearance from images. Although the present disclosure may be described with respect to the system 100 an example autonomous vehicle 1100 (alternatively referred to herein as “vehicle 1100” or “ego-vehicle 1100,” an example of which is described with respect to FIGS. 11A-11D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to autonomous vehicle simulation, training, and verification, this is not intended to be limiting, and the systems and methods described herein may be used in augmented reality, virtual reality, mixed reality, robotics, security and surveillance, autonomous or semi-autonomous machine applications, and/or any other technology spaces where recovering and reconstructing 3D geometry and appearance from images may be used.

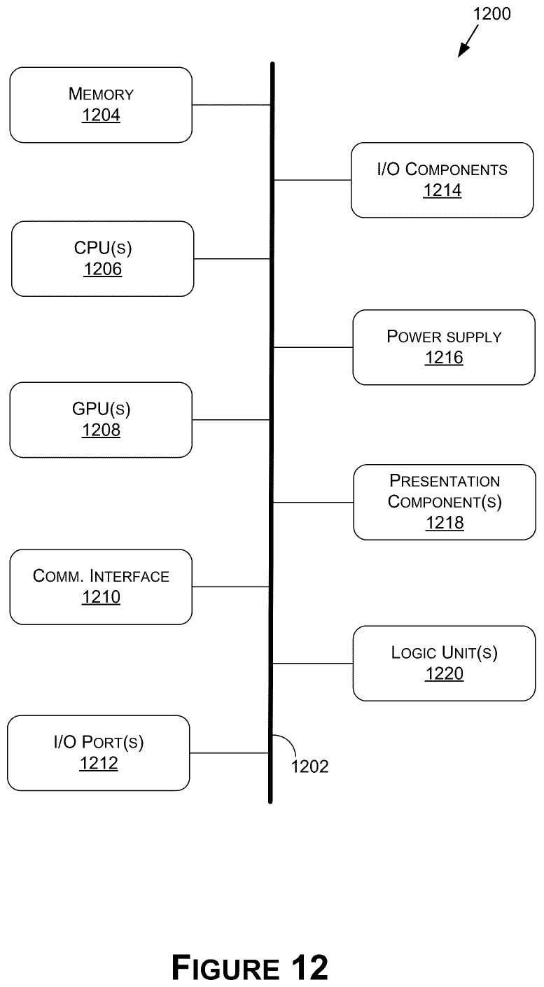

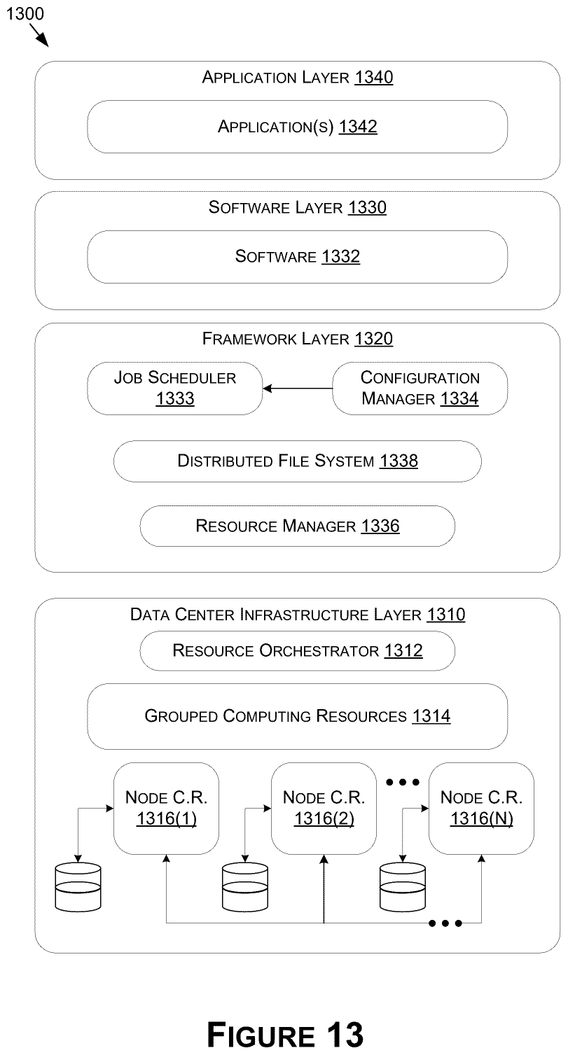

In some embodiments, the systems, methods, and processes described herein may be executed using similar components, features, and/or functionality to those of example autonomous vehicle 1100 of FIGS. 11A-11D, example computing device 1200 of FIG. 12, and/or example data center 1300 of FIG. 13. For example, the methods, pipelines, and system components shown in and described with respect to FIGS. 1-10 can be implemented using at least one processor and at least one memory in one or more of the autonomous vehicle 1100, the computing device 1200, or the data center 130.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), neural representation techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using USD data, such as OpenUSD, computer aided design (CAD) data, 2D and/or 3D graphics or design data, and/or other data types), systems implemented at least partially using cloud computing resources, and/or other types of systems.

FIG. 11A is an illustration of an example autonomous vehicle 1100, in accordance with some embodiments of the present disclosure. The autonomous vehicle 1100 (alternatively referred to herein as the “vehicle 1100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1100 may be capable of functionality in accordance with one or more of Level 3-Level 5 of the autonomous driving levels. The vehicle 1100 may be capable of functionality in accordance with one or more of Level 1-Level 5 of the autonomous driving levels. For example, the vehicle 1100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1100 or other machine, such as being fully autonomous, being highly autonomous, being conditionally autonomous, being partially autonomous, providing assistive autonomy, being semi-autonomous, being primarily autonomous, or other designation.

The vehicle 1100 may include components such as a chassis, a vehicle body, wheels (e.g., 2, 4, 6, 8, 18, etc.), tires, axles, and other components of a vehicle. The vehicle 1100 may include a propulsion system 1150, such as an internal combustion engine, hybrid electric power plant, an all-electric engine, and/or another propulsion system type. The propulsion system 1150 may be connected to a drive train of the vehicle 1100, which may include a transmission, to enable the propulsion of the vehicle 1100. The propulsion system 1150 may be controlled in response to receiving signals from the throttle/accelerator 1152.

A steering system 1154, which may include a steering wheel, may be used to steer the vehicle 1100 (e.g., along a desired path or route) when the propulsion system 1150 is operating (e.g., when the vehicle is in motion). The steering system 1154 may receive signals from a steering actuator 1156. The steering wheel may be optional for full automation (Level 5) functionality.

The brake sensor system 1146 may be used to operate the vehicle brakes in response to receiving signals from the brake actuators 1148 and/or brake sensors.

Controller(s) 1136, which may include one or more system on chips (SoCs) 1104 (FIG. 11C) and/or GPU(s), may provide signals (e.g., representative of commands) to one or more components and/or systems of the vehicle 1100. For example, the controller(s) may send signals to operate the vehicle brakes via one or more brake actuators 1148, to operate the steering system 1154 via one or more steering actuators 1156, to operate the propulsion system 1150 via one or more throttle/accelerators 1152. The controller(s) 1136 may include one or more onboard (e.g., integrated) computing devices (e.g., supercomputers) that process sensor signals, and output operation commands (e.g., signals representing commands) to enable autonomous driving and/or to assist a human driver in driving the vehicle 1100. The controller(s) 1136 may include a first controller 1136 for autonomous driving functions, a second controller 1136 for functional safety functions, a third controller 1136 for artificial intelligence functionality (e.g., computer vision), a fourth controller 1136 for infotainment functionality, a fifth controller 1136 for redundancy in emergency conditions, and/or other controllers. In some examples, a single controller 1136 may handle two or more of the above functionalities, two or more controllers 1136 may handle a single functionality, and/or any combination thereof.

The controller(s) 1136 may provide the signals for controlling one or more components and/or systems of the vehicle 1100 in response to sensor data received from one or more sensors (e.g., sensor inputs). The sensor data may be received from, for example and without limitation, global navigation satellite systems (“GNSS”) sensor(s) 1158 (e.g., Global Positioning System sensor(s)), RADAR sensor(s) 1160, ultrasonic sensor(s) 1162, LIDAR sensor(s) 1164, inertial measurement unit (IMU) sensor(s) 1166 (e.g., accelerometer(s), gyroscope(s), magnetic compass(es), magnetometer(s), etc.), microphone(s) 1196, stereo camera(s) 1168, wide-view camera(s) 1170 (e.g., fisheye cameras), infrared camera(s) 1172, surround camera(s) 1174 (e.g., 360 degree cameras), long-range and/or mid-range camera(s) 1198, speed sensor(s) 1144 (e.g., for measuring the speed of the vehicle 1100), vibration sensor(s) 1142, steering sensor(s) 1140, brake sensor(s) (e.g., as part of the brake sensor system 1146), and/or other sensor types.

One or more of the controller(s) 1136 may receive inputs (e.g., represented by input data) from an instrument cluster 1132 of the vehicle 1100 and provide outputs (e.g., represented by output data, display data, etc.) via a human-machine interface (HMI) display 1134, an audible annunciator, a loudspeaker, and/or via other components of the vehicle 1100. The outputs may include information such as vehicle velocity, speed, time, map data (e.g., the High Definition (“HD”) map 1122 of FIG. 11C), location data (e.g., the vehicle's 1100 location, such as on a map), direction, location of other vehicles (e.g., an occupancy grid), information about objects and status of objects as perceived by the controller(s) 1136, etc. For example, the HMI display 1134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1100 further includes a network interface 1124 which may use one or more wireless antenna(s) 1126 and/or modem(s) to communicate over one or more networks. For example, the network interface 1124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 11B is an example of camera locations and fields of view for the example autonomous vehicle 1100 of FIG. 11A, in accordance with some embodiments of the present disclosure. The cameras and respective fields of view are one example embodiment and are not intended to be limiting. For example, additional and/or alternative cameras may be included and/or the cameras may be located at different locations on the vehicle 1100.

The camera types for the cameras may include, but are not limited to, digital cameras that may be adapted for use with the components and/or systems of the vehicle 1100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1100 (e.g., front-facing cameras) may be used for surround view, to help identify forward facing paths and obstacles, as well aid in, with the help of one or more controllers 1136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1170 that may be used to perceive objects coming into view from the periphery (e.g., pedestrians, crossing traffic or bicycles). Although only one wide-view camera is illustrated in FIG. 11B, there may be any number (including zero) of wide-view cameras 1170 on the vehicle 1100. In addition, any number of long-range camera(s) 1198 (e.g., a long-view stereo camera pair) may be used for depth-based object detection, especially for objects for which a neural network has not yet been trained. The long-range camera(s) 1198 may also be used for object detection and classification, as well as basic object tracking.

Any number of stereo cameras 1168 may also be included in a front-facing configuration. In at least one embodiment, one or more of stereo camera(s) 1168 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1168 may be used in addition to, or alternatively from, those described herein.

Cameras with a field of view that include portions of the environment to the side of the vehicle 1100 (e.g., side-view cameras) may be used for surround view, providing information used to create and update the occupancy grid, as well as to generate side impact collision warnings. For example, surround camera(s) 1174 (e.g., four surround cameras 1174 as illustrated in FIG. 11B) may be positioned to on the vehicle 1100. The surround camera(s) 1174 may include wide-view camera(s) 1170, fisheye camera(s), 360 degree camera(s), and/or the like. Four example, four fisheye cameras may be positioned on the vehicle's front, rear, and sides. In an alternative arrangement, the vehicle may use three surround camera(s) 1174 (e.g., left, right, and rear), and may leverage one or more other camera(s) (e.g., a forward-facing camera) as a fourth surround view camera.

Cameras with a field of view that include portions of the environment to the rear of the vehicle 1100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1198, stereo camera(s) 1168), infrared camera(s) 1172, etc.), as described herein.

FIG. 11C is a block diagram of an example system architecture for the example autonomous vehicle 1100 of FIG. 11A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1100 in FIG. 11C are illustrated as being connected via bus 1102. The bus 1102 may include a Controller Area Network (CAN) data interface (alternatively referred to herein as a “CAN bus”). A CAN may be a network inside the vehicle 1100 used to aid in control of various features and functionality of the vehicle 1100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1102 is described herein as being a CAN bus, this is not intended to be limiting. For example, in addition to, or alternatively from, the CAN bus, FlexRay and/or Ethernet may be used. Additionally, although a single line is used to represent the bus 1102, this is not intended to be limiting. For example, there may be any number of busses 1102, which may include one or more CAN busses, one or more FlexRay busses, one or more Ethernet busses, and/or one or more other types of busses using a different protocol. In some examples, two or more busses 1102 may be used to perform different functions, and/or may be used for redundancy. For example, a first bus 1102 may be used for collision avoidance functionality and a second bus 1102 may be used for actuation control. In any example, each bus 1102 may communicate with any of the components of the vehicle 1100, and two or more busses 1102 may communicate with the same components. In some examples, each SoC 1104, each controller 1136, and/or each computer within the vehicle may have access to the same input data (e.g., inputs from sensors of the vehicle 1100), and may be connected to a common bus, such the CAN bus.

The vehicle 1100 may include one or more controller(s) 1136, such as those described herein with respect to FIG. 11A. The controller(s) 1136 may be used for a variety of functions. The controller(s) 1136 may be coupled to any of the various other components and systems of the vehicle 1100, and may be used for control of the vehicle 1100, artificial intelligence of the vehicle 1100, infotainment for the vehicle 1100, and/or the like.

The vehicle 1100 may include a system(s) on a chip (SoC) 1104. The SoC 1104 may include CPU(s) 1106, GPU(s) 1108, processor(s) 1110, cache(s) 1112, accelerator(s) 1114, data store(s) 1116, and/or other components and features not illustrated. The SoC(s) 1104 may be used to control the vehicle 1100 in a variety of platforms and systems. For example, the SoC(s) 1104 may be combined in a system (e.g., the system of the vehicle 1100) with an HD map 1122 which may obtain map refreshes and/or updates via a network interface 1124 from one or more servers (e.g., server(s) 1178 of FIG. 11D).

The CPU(s) 1106 may include a CPU cluster or CPU complex (alternatively referred to herein as a “CCPLEX”). The CPU(s) 1106 may include multiple cores and/or L2 caches. For example, in some embodiments, the CPU(s) 1106 may include eight cores in a coherent multi-processor configuration. In some embodiments, the CPU(s) 1106 may include four dual-core clusters where each cluster has a dedicated L2 cache (e.g., a 2 MB L2 cache). The CPU(s) 1106 (e.g., the CCPLEX) may be configured to support simultaneous cluster operation enabling any combination of the clusters of the CPU(s) 1106 to be active at any given time.

The CPU(s) 1106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1108 may include an integrated GPU (alternatively referred to herein as an “iGPU”). The GPU(s) 1108 may be programmable and may be efficient for parallel workloads. The GPU(s) 1108, in some examples, may use an enhanced tensor instruction set. The GPU(s) 1108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1108 may include at least eight streaming microprocessors. The GPU(s) 1108 may use compute application programming interface(s) (API(s)). In addition, the GPU(s) 1108 may use one or more parallel computing platforms and/or programming models (e.g., NVIDIA's CUDA).

The GPU(s) 1108 may be power-optimized for best performance in automotive and embedded use cases. For example, the GPU(s) 1108 may be fabricated on a Fin field-effect transistor (FinFET). However, this is not intended to be limiting and the GPU(s) 1108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1108 to access the CPU(s) 1106 page tables directly. In such examples, when the GPU(s) 1108 memory management unit (MMU) experiences a miss, an address translation request may be transmitted to the CPU(s) 1106. In response, the CPU(s) 1106 may look in its page tables for the virtual-to-physical mapping for the address and transmits the translation back to the GPU(s) 1108. As such, unified memory technology may allow a single unified virtual address space for memory of both the CPU(s) 1106 and the GPU(s) 1108, thereby simplifying the GPU(s) 1108 programming and porting of applications to the GPU(s) 1108.

In addition, the GPU(s) 1108 may include an access counter that may keep track of the frequency of access of the GPU(s) 1108 to memory of other processors. The access counter may help ensure that memory pages are moved to the physical memory of the processor that is accessing the pages most frequently.

The SoC(s) 1104 may include any number of cache(s) 1112, including those described herein. For example, the cache(s) 1112 may include an L3 cache that is available to both the CPU(s) 1106 and the GPU(s) 1108 (e.g., that is connected both the CPU(s) 1106 and the GPU(s) 1108). The cache(s) 1112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1104 may include an arithmetic logic unit(s) (ALU(s)) which may be leveraged in performing processing with respect to any of the variety of tasks or operations of the vehicle 1100—such as processing DNNs. In addition, the SoC(s) 1104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1106 and/or GPU(s) 1108.

The SoC(s) 1104 may include one or more accelerators 1114 (e.g., hardware accelerators, software accelerators, or a combination thereof). For example, the SoC(s) 1104 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1108 and to off-load some of the tasks of the GPU(s) 1108 (e.g., to free up more cycles of the GPU(s) 1108 for performing other tasks). As an example, the accelerator(s) 1114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1108, and by using an inference accelerator, for example, a designer may target either the DLA(s) or the GPU(s) 1108 for any function. For example, the designer may focus processing of CNNs and floating point operations on the DLA(s) and leave other functions to the GPU(s) 1108 and/or other accelerator(s) 1114.

The accelerator(s) 1114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1114 (e.g., the hardware acceleration cluster) may include a computer vision network on-chip and SRAM, for providing a high-bandwidth, low latency SRAM for the accelerator(s) 1114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1166 output that correlates with the vehicle 1100 orientation, distance, 3D location estimates of the object obtained from the neural network and/or other sensors (e.g., LIDAR sensor(s) 1164 or RADAR sensor(s) 1160), among others.

The SoC(s) 1104 may include data store(s) 1116 (e.g., memory). The data store(s) 1116 may be on-chip memory of the SoC(s) 1104, which may store neural networks to be executed on the GPU and/or the DLA. In some examples, the data store(s) 1116 may be large enough in capacity to store multiple instances of neural networks for redundancy and safety. The data store(s) 1112 may comprise L2 or L3 cache(s) 1112. Reference to the data store(s) 1116 may include reference to the memory associated with the PVA, DLA, and/or other accelerator(s) 1114, as described herein.

The SoC(s) 1104 may include one or more processor(s) 1110 (e.g., embedded processors). The processor(s) 1110 may include a boot and power management processor that may be a dedicated processor and subsystem to handle boot power and management functions and related security enforcement. The boot and power management processor may be a part of the SoC(s) 1104 boot sequence and may provide runtime power management services. The boot power and management processor may provide clock and voltage programming, assistance in system low power state transitions, management of SoC(s) 1104 thermals and temperature sensors, and/or management of the SoC(s) 1104 power states. Each temperature sensor may be implemented as a ring-oscillator whose output frequency is proportional to temperature, and the SoC(s) 1104 may use the ring-oscillators to detect temperatures of the CPU(s) 1106, GPU(s) 1108, and/or accelerator(s) 1114. If temperatures are determined to exceed a threshold, the boot and power management processor may enter a temperature fault routine and put the SoC(s) 1104 into a lower power state and/or put the vehicle 1100 into a chauffeur to safe stop mode (e.g., bring the vehicle 1100 to a safe stop).

The processor(s) 1110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1110 may further include a real-time camera engine that may include a dedicated processor subsystem for handling real-time camera management.

The processor(s) 1110 may further include a high-dynamic range signal processor that may include an image signal processor that is a hardware engine that is part of the camera processing pipeline.

The processor(s) 1110 may include a video image compositor that may be a processing block (e.g., implemented on a microprocessor) that implements video post-processing functions needed by a video playback application to produce the final image for the player window. The video image compositor may perform lens distortion correction on wide-view camera(s) 1170, surround camera(s) 1174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1108 is not required to continuously render new surfaces. Even when the GPU(s) 1108 is powered on and active doing 3D rendering, the video image compositor may be used to offload the GPU(s) 1108 to improve performance and responsiveness.

The SoC(s) 1104 may further include a mobile industry processor interface (MIPI) camera serial interface for receiving video and input from cameras, a high-speed interface, and/or a video input block that may be used for camera and related pixel input functions. The SoC(s) 1104 may further include an input/output controller(s) that may be controlled by software and may be used for receiving I/O signals that are uncommitted to a specific role.

The SoC(s) 1104 may further include a broad range of peripheral interfaces to enable communication with peripherals, audio codecs, power management, and/or other devices. The SoC(s) 1104 may be used to process data from cameras (e.g., connected over Gigabit Multimedia Serial Link and Ethernet), sensors (e.g., LIDAR sensor(s) 1164, RADAR sensor(s) 1160, etc. that may be connected over Ethernet), data from bus 1102 (e.g., speed of vehicle 1100, steering wheel position, etc.), data from GNSS sensor(s) 1158 (e.g., connected over Ethernet or CAN bus). The SoC(s) 1104 may further include dedicated high-performance mass storage controllers that may include their own DMA engines, and that may be used to free the CPU(s) 1106 from routine data management tasks.

The SoC(s) 1104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1104 may be faster, more reliable, and even more energy-efficient and space-efficient than conventional systems. For example, the accelerator(s) 1114, when combined with the CPU(s) 1106, the GPU(s) 1108, and the data store(s) 1116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1108.

In some examples, a CNN for facial recognition and vehicle owner identification may use data from camera sensors to identify the presence of an authorized driver and/or owner of the vehicle 1100. The always on sensor processing engine may be used to unlock the vehicle when the owner approaches the driver door and turn on the lights, and, in security mode, to disable the vehicle when the owner leaves the vehicle. In this way, the SoC(s) 1104 provide for security against theft and/or carjacking.

In another example, a CNN for emergency vehicle detection and identification may use data from microphones 1196 to detect and identify emergency vehicle sirens. In contrast to conventional systems, that use general classifiers to detect sirens and manually extract features, the SoC(s) 1104 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1162, until the emergency vehicle(s) passes.

The vehicle may include a CPU(s) 1118 (e.g., discrete CPU(s), or dCPU(s)), that may be coupled to the SoC(s) 1104 via a high-speed interconnect (e.g., PCIe). The CPU(s) 1118 may include an X86 processor, for example. The CPU(s) 1118 may be used to perform any of a variety of functions, including arbitrating potentially inconsistent results between ADAS sensors and the SoC(s) 1104, and/or monitoring the status and health of the controller(s) 1136 and/or infotainment SoC 1130, for example.

The vehicle 1100 may include a GPU(s) 1120 (e.g., discrete GPU(s), or dGPU(s)), that may be coupled to the SoC(s) 1104 via a high-speed interconnect (e.g., NVIDIA's NVLINK). The GPU(s) 1120 may provide additional artificial intelligence functionality, such as by executing redundant and/or different neural networks, and may be used to train and/or update neural networks based on input (e.g., sensor data) from sensors of the vehicle 1100.

The vehicle 1100 may further include the network interface 1124 which may include one or more wireless antennas 1126 (e.g., one or more wireless antennas for different communication protocols, such as a cellular antenna, a Bluetooth antenna, etc.). The network interface 1124 may be used to enable wireless connectivity over the Internet with the cloud (e.g., with the server(s) 1178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1100 information about vehicles in proximity to the vehicle 1100 (e.g., vehicles in front of, on the side of, and/or behind the vehicle 1100). This functionality may be part of a cooperative adaptive cruise control functionality of the vehicle 1100.

The network interface 1124 may include a SoC that provides modulation and demodulation functionality and enables the controller(s) 1136 to communicate over wireless networks. The network interface 1124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1100 may further include data store(s) 1128 which may include off-chip (e.g., off the SoC(s) 1104) storage. The data store(s) 1128 may include one or more storage elements including RAM, SRAM, DRAM, VRAM, Flash, hard disks, and/or other components and/or devices that may store at least one bit of data.

The vehicle 1100 may further include GNSS sensor(s) 1158. The GNSS sensor(s) 1158 (e.g., GPS, assisted GPS sensors, differential GPS (DGPS) sensors, etc.), to assist in mapping, perception, occupancy grid generation, and/or path planning functions. Any number of GNSS sensor(s) 1158 may be used, including, for example and without limitation, a GPS using a USB connector with an Ethernet to Serial (RS-232) bridge.

The vehicle 1100 may further include RADAR sensor(s) 1160. The RADAR sensor(s) 1160 may be used by the vehicle 1100 for long-range vehicle detection, even in darkness and/or severe weather conditions. RADAR functional safety levels may be ASIL B. The RADAR sensor(s) 1160 may use the CAN and/or the bus 1102 (e.g., to transmit data generated by the RADAR sensor(s) 1160) for control and to access object tracking data, with access to Ethernet to access raw data in some examples. A wide variety of RADAR sensor types may be used. For example, and without limitation, the RADAR sensor(s) 1160 may be suitable for front, rear, and side RADAR use. In some example, Pulse Doppler RADAR sensor(s) are used.

The RADAR sensor(s) 1160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1100 surroundings at higher speeds with minimal interference from traffic in adjacent lanes. The other two antennae may expand the field of view, making it possible to quickly detect vehicles entering or leaving the vehicle's 1100 lane.

Mid-range RADAR systems may include, as an example, a range of up to 1160 m (front) or 80 m (rear), and a field of view of up to 42 degrees (front) or 1150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1100 may further include ultrasonic sensor(s) 1162. The ultrasonic sensor(s) 1162, which may be positioned at the front, back, and/or the sides of the vehicle 1100, may be used for park assist and/or to create and update an occupancy grid. A wide variety of ultrasonic sensor(s) 1162 may be used, and different ultrasonic sensor(s) 1162 may be used for different ranges of detection (e.g., 2.5 m, 4 m). The ultrasonic sensor(s) 1162 may operate at functional safety levels of ASIL B.

The vehicle 1100 may include LIDAR sensor(s) 1164. The LIDAR sensor(s) 1164 may be used for object and pedestrian detection, emergency braking, collision avoidance, and/or other functions. The LIDAR sensor(s) 1164 may be functional safety level ASIL B. In some examples, the vehicle 1100 may include multiple LIDAR sensors 1164 (e.g., two, four, six, etc.) that may use Ethernet (e.g., to provide data to a Gigabit Ethernet switch).

In some examples, the LIDAR sensor(s) 1164 may be capable of providing a list of objects and their distances for a 360-degree field of view. Commercially available LIDAR sensor(s) 1164 may have an advertised range of approximately 1100 m, with an accuracy of 2 cm-3 cm, and with support for a 1100 Mbps Ethernet connection, for example. In some examples, one or more non-protruding LIDAR sensors 1164 may be used. In such examples, the LIDAR sensor(s) 1164 may be implemented as a small device that may be embedded into the front, rear, sides, and/or corners of the vehicle 1100. The LIDAR sensor(s) 1164, in such examples, may provide up to a 120-degree horizontal and 35-degree vertical field-of-view, with a 200 m range even for low-reflectivity objects. Front-mounted LIDAR sensor(s) 1164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1164 may be less susceptible to motion blur, vibration, and/or shock.

The vehicle may further include IMU sensor(s) 1166. The IMU sensor(s) 1166 may be located at a center of the rear axle of the vehicle 1100, in some examples. The IMU sensor(s) 1166 may include, for example and without limitation, an accelerometer(s), a magnetometer(s), a gyroscope(s), a magnetic compass(es), and/or other sensor types. In some examples, such as in six-axis applications, the IMU sensor(s) 1166 may include accelerometers and gyroscopes, while in nine-axis applications, the IMU sensor(s) 1166 may include accelerometers, gyroscopes, and magnetometers.

In some embodiments, the IMU sensor(s) 1166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1166 may enable the vehicle 1100 to estimate heading without requiring input from a magnetic sensor by directly observing and correlating the changes in velocity from GPS to the IMU sensor(s) 1166. In some examples, the IMU sensor(s) 1166 and the GNSS sensor(s) 1158 may be combined in a single integrated unit.

The vehicle may include microphone(s) 1196 placed in and/or around the vehicle 1100. The microphone(s) 1196 may be used for emergency vehicle detection and identification, among other things.

The vehicle may further include any number of camera types, including stereo camera(s) 1168, wide-view camera(s) 1170, infrared camera(s) 1172, surround camera(s) 1174, long-range and/or mid-range camera(s) 1198, and/or other camera types. The cameras may be used to capture image data around an entire periphery of the vehicle 1100. The types of cameras used depends on the embodiments and requirements for the vehicle 1100, and any combination of camera types may be used to provide the necessary coverage around the vehicle 1100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 11A and FIG. 11B.

The vehicle 1100 may further include vibration sensor(s) 1142. The vibration sensor(s) 1142 may measure vibrations of components of the vehicle, such as the axle(s). For example, changes in vibrations may indicate a change in road surfaces. In another example, when two or more vibration sensors 1142 are used, the differences between the vibrations may be used to determine friction or slippage of the road surface (e.g., when the difference in vibration is between a power-driven axle and a freely rotating axle).

The vehicle 1100 may include an ADAS system 1138. The ADAS system 1138 may include a SoC, in some examples. The ADAS system 1138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1160, LIDAR sensor(s) 1164, and/or a camera(s). The ACC systems may include longitudinal ACC and/or lateral ACC. Longitudinal ACC monitors and controls the distance to the vehicle immediately ahead of the vehicle 1100 and automatically adjust the vehicle speed to maintain a safe distance from vehicles ahead. Lateral ACC performs distance keeping, and advises the vehicle 1100 to change lanes when necessary. Lateral ACC is related to other ADAS applications such as LCA and CWS.

CACC uses information from other vehicles that may be received via the network interface 1124 and/or the wireless antenna(s) 1126 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1100), while the I2V communication concept provides information about traffic further ahead. CACC systems may include either or both I2V and V2V information sources. Given the information of the vehicles ahead of the vehicle 1100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1100 if the vehicle 1100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1100 is backing up. Some RCTW systems include AEB to ensure that the vehicle brakes are applied to avoid a crash. RCTW systems may use one or more rear-facing RADAR sensor(s) 1160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1100, the vehicle 1100 itself must, in the case of conflicting results, decide whether to heed the result from a primary computer or a secondary computer (e.g., a first controller 1136 or a second controller 1136). For example, in some embodiments, the ADAS system 1138 may be a backup and/or secondary computer for providing perception information to a backup computer rationality module. The backup computer rationality monitor may run a redundant diverse software on hardware components to detect faults in perception and dynamic driving tasks. Outputs from the ADAS system 1138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1104.

In other examples, ADAS system 1138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1138 may be fed into the primary computer's perception block and/or the primary computer's dynamic driving task block. For example, if the ADAS system 1138 indicates a forward crash warning due to an object immediately ahead, the perception block may use this information when identifying objects. In other examples, the secondary computer may have its own neural network which is trained and thus reduces the risk of false positives, as described herein.

The vehicle 1100 may further include the infotainment SoC 1130 (e.g., an in-vehicle infotainment system (IVI)). Although illustrated and described as a SoC, the infotainment system may not be a SoC, and may include two or more discrete components. The infotainment SoC 1130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1100. For example, the infotainment SoC 1130 may radios, disk players, navigation systems, video players, USB and Bluetooth connectivity, carputers, in-car entertainment, Wi-Fi, steering wheel audio controls, hands free voice control, a heads-up display (HUD), an HMI display 1134, a telematics device, a control panel (e.g., for controlling and/or interacting with various components, features, and/or systems), and/or other components. The infotainment SoC 1130 may further be used to provide information (e.g., visual and/or audible) to a user(s) of the vehicle, such as information from the ADAS system 1138, autonomous driving information such as planned vehicle maneuvers, trajectories, surrounding environment information (e.g., intersection information, vehicle information, road information, etc.), and/or other information.

The infotainment SoC 1130 may include GPU functionality. The infotainment SoC 1130 may communicate over the bus 1102 (e.g., CAN bus, Ethernet, etc.) with other devices, systems, and/or components of the vehicle 1100. In some examples, the infotainment SoC 1130 may be coupled to a supervisory MCU such that the GPU of the infotainment system may perform some self-driving functions in the event that the primary controller(s) 1136 (e.g., the primary and/or backup computers of the vehicle 1100) fail. In such an example, the infotainment SoC 1130 may put the vehicle 1100 into a chauffeur to safe stop mode, as described herein.

The vehicle 1100 may further include an instrument cluster 1132 (e.g., a digital dash, an electronic instrument cluster, a digital instrument panel, etc.). The instrument cluster 1132 may include a controller and/or supercomputer (e.g., a discrete controller or supercomputer). The instrument cluster 1132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1130 and the instrument cluster 1132. In other words, the instrument cluster 1132 may be included as part of the infotainment SoC 1130, or vice versa.

FIG. 11D is a system diagram for communication between cloud-based server(s) and the example autonomous vehicle 1100 of FIG. 11A, in accordance with some embodiments of the present disclosure. The system 1176 may include server(s) 1178, network(s) 1190, and vehicles, including the vehicle 1100. The server(s) 1178 may include a plurality of GPUs 1184(A)-1184(H) (collectively referred to herein as GPUs 1184), PCIe switches 1182(A)-1182(H) (collectively referred to herein as PCIe switches 1182), and/or CPUs 1180(A)-1180(B) (collectively referred to herein as CPUs 1180). The GPUs 1184, the CPUs 1180, and the PCIe switches may be interconnected with high-speed interconnects such as, for example and without limitation, NVLink interfaces 1188 developed by NVIDIA and/or PCIe connections 1186. In some examples, the GPUs 1184 are connected via NVLink and/or NVSwitch SoC and the GPUs 1184 and the PCIe switches 1182 are connected via PCIe interconnects. Although eight GPUs 1184, two CPUs 1180, and two PCIe switches are illustrated, this is not intended to be limiting. Depending on the embodiment, each of the server(s) 1178 may include any number of GPUs 1184, CPUs 1180, and/or PCIe switches. For example, the server(s) 1178 may each include eight, sixteen, thirty-two, and/or more GPUs 1184.

The server(s) 1178 may receive, over the network(s) 1190 and from the vehicles, image data representative of images showing unexpected or changed road conditions, such as recently commenced road-work. The server(s) 1178 may transmit, over the network(s) 1190 and to the vehicles, neural networks 1192, updated neural networks 1192, and/or map information 1194, including information regarding traffic and road conditions. The updates to the map information 1194 may include updates for the HD map 1122, such as information regarding construction sites, potholes, detours, flooding, and/or other obstructions. In some examples, the neural networks 1192, the updated neural networks 1192, and/or the map information 1194 may have resulted from new training and/or experiences represented in data received from any number of vehicles in the environment, and/or based on training performed at a datacenter (e.g., using the server(s) 1178 and/or other servers).

The server(s) 1178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1190, and/or the machine learning models may be used by the server(s) 1178 to remotely monitor the vehicles.

In some examples, the server(s) 1178 may receive data from the vehicles and apply the data to up-to-date real-time neural networks for real-time intelligent inferencing. The server(s) 1178 may include deep-learning supercomputers and/or dedicated AI computers powered by GPU(s) 1184, such as a DGX and DGX Station machines developed by NVIDIA. However, in some examples, the server(s) 1178 may include deep learning infrastructure that use only CPU-powered datacenters.

The deep-learning infrastructure of the server(s) 1178 may be capable of fast, real-time inferencing, and may use that capability to evaluate and verify the health of the processors, software, and/or associated hardware in the vehicle 1100. For example, the deep-learning infrastructure may receive periodic updates from the vehicle 1100, such as a sequence of images and/or objects that the vehicle 1100 has located in that sequence of images (e.g., via computer vision and/or other machine learning object classification techniques). The deep-learning infrastructure may run its own neural network to identify the objects and compare them with the objects identified by the vehicle 1100 and, if the results do not match and the infrastructure concludes that the AI in the vehicle 1100 is malfunctioning, the server(s) 1178 may transmit a signal to the vehicle 1100 instructing a fail-safe computer of the vehicle 1100 to assume control, notify the passengers, and complete a safe parking maneuver.

For inferencing, the server(s) 1178 may include the GPU(s) 1184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. At least one processor comprising one or more circuits to implement:
a first network, comprising:
a first diffusion model to generate a first voxel grid representative of a three-dimensional (3D) scene and having a first resolution, the first diffusion model being conditioned using at least one input image;
a second diffusion model to generate a second voxel grid representative of the 3D scene and having a second resolution, the second diffusion model being conditioned using the first voxel grid; and
a second network to:
predict one or more Gaussian attributes within one or more voxels of the second voxel grid;
determine a representation of a distant portion of the 3D scene using the at least one input image; and
compose a novel view of the 3D scene based at least in part on the one or more Gaussian attributes and the representation of a distant portion of the 3D scene.

2. The at least one processor of claim 1, wherein the at least one input image comprises a plurality of images of a scene from a plurality of camera poses, wherein the plurality of images are non-overlapping.

3. The at least one processor of claim 1, wherein
each of the first diffusion model or the second diffusion model comprises a voxel latent diffusion model; and
the first diffusion model and the second diffusion model are a same model.

4. The at least one processor of claim 1, wherein the first diffusion model is conditioned on a three dimensional (3D) representation of the at least one input image.

5. The at least one processor of claim 1, wherein the 3D representation of the at least one input image comprises at least one input feature cube.

6. The at least one processor of claim 1, wherein the first network is a generative geometry network to determine the 3D representation of the scene from the at least one input image by:
extracting one or more features from the at least one input image; and
unprojecting the one or more extracted features into the 3D representation.

7. The at least one processor of claim 1, wherein the first network is to determine the 3D representation from the at least one input image by:
extracting one or more features from the at least one input image;
concatenating the one or more extracted features with one or more embeddings computed from coordinates of pixel rays from pixels of the at least one input image to obtain one or more concatenated features;
processing the one or more concatenated features using multiple two dimensional (2D) convolution layers and split processed concatenated features into two branches; and
unprojecting the split processed concatenated features to the 3D representation.

8. The at least one processor of claim 1, wherein
a first noise and a first condition corresponding to the at least one input image are encoded into the first diffusion model, which in response outputs the first voxel grid; and
a second noise and a second condition comprising the first voxel grid are encoded into the second diffusion model, which in response outputs the second voxel grid.

9. The at least one processor of claim 1, wherein at least one of the one or more Gaussian attributes comprises at least one of: a position, a rotation, a scaling, an opacity, a color of a voxel.

10. The at least one processor of claim 1, wherein predicting the one or more Gaussian attributes comprises:
retrieving one or more image features of the at least one input image from the second voxel grid;
gathering the one or more retrieved image features; and
decoding the one or more gathered image features for at least one voxel of the second voxel grid to obtain the Gaussian attributes.

11. The at least one processor of claim 10, wherein the one or more Gaussian attributes comprise at least one Gaussian attribute for each voxel of the second voxel grid.

12. The at least one processor of claim 10, wherein at least one of the one or more Gaussian attributes predicted for one or more voxels of the second voxel grid comprises a VoxSplat.

13. The at least one processor of claim 1, wherein the distant portion of the 3D scene corresponds to a sky, the representation of the distant portion of the 3D scene comprises a composite representation, and determining the representation of a distant portion of the 3D scene comprises:
determining, using a feed-forward network, a feature image based at least in part on the at least one input image; and
determining, using a two dimensional (2D) neural network, the representation of the distant portion of the 3D scene based at least in part on the feature image.

14. The at least one processor of claim 1, wherein composing the novel view comprises:
rendering the one or more Gaussian attributes and the second voxel grid from a viewpoint to obtain a first two-dimensional (2D) image;
rendering the representation of a distant portion of the 3D scene from the viewpoint to obtain a second 2D image; and
combining the first 2D image and the second 2D image to form the novel view.

15. The at least one processor of claim 1, wherein the one or more circuits are further to implement a Generative Adversarial Network (GAN) to output a refined image using the novel view as input.

16. The at least one processor of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing vision language models (VLMs);
a system implementing large language models (LLMs);
a system implementing multi-modal language models;
a system for hosting one or more real-time streaming applications;
a system for performing light transport simulation;
a system for performing collaborative content creation for 3D assets; or
a system implemented at least partially using cloud computing resources.

17. At least one processor comprising one or more circuits to:
generate a first voxel grid having a first resolution and being conditioned on at least one input image;
generate a second voxel grid having a second resolution and being conditioned on the first voxel grid, wherein the first voxel grid and the second voxel grid represent a three dimensional (3D) scene;
predict one or more Gaussian attributes within one or more voxels of the second voxel grid;
determine a representation of a portion of the 3D scene corresponding to a sky using the at least one input image; and
compose a novel view of the 3D scene based at least in part on the one or more Gaussian attributes and the representation of a distant portion of the 3D scene.

18. At least one processor comprising one or more circuits to:
update at least one Variational Autoencoder (VAE) to learn a latent space over a sparse voxel hierarchy, the sparse voxel hierarchy comprising a first voxel grid having a first resolution and a second voxel grid having a second resolution generated using the at least one VAE, wherein the second resolution is greater than the first resolution;
add semantic logit prediction to the second voxel grid; and
update at least one diffusion model conditioned on three-dimensional (3D) data associated with two-dimensional (2D) images.

19. The at least one processor of claim 18, wherein the one or more circuits to:
accumulate the 3D data in a world space over a period of time, wherein the 3D data comprises a plurality of points defining the world space;
remove one or more points of the plurality of points that are within one or more bounding boxes corresponding to one or more dynamic objects in the world space;
obtain semantics of at least one point of the plurality of points;
apply a multi-view stereo (MVS) algorithm to a plurality of 2D images to reconstruct a dense 3D point cloud and obtain semantic information corresponding to the dense 3D point cloud; and
add one or more point samples for the dynamic objects according to the bounding boxes at a target frame.

20. The at least one processor of claim 18, wherein the 3D data comprises Light Detection and Ranging (LiDAR) data captured on at least one autonomous vehicle on which the 2D images are captured.
